(19) United States
(12) Patent Application Publication
(10) Pub. No.: US 2023/0168081 A1
(43) Pub. Date: Jun. 1, 2023

(54) SYSTEM AND METHOD FOR 3D IMAGE SCANNING

(71) Applicant: The Research Foundation for The State Unviersity of New York, Albany, NY (US)

(72) Inventor: XIANFENG GU, (US)

(21) Appl. No.: 17/917,937

(22) PCT Filed: Apr. 12, 2021
(86) PCT No.: PCT/US21/26799

§ 371 Date: Oct. 9, 2022

Related U.S. Application Data
(60) Provisional application No. 63/008,268, filed on Apr. 10, 2020.

(30) Foreign Application Priority Data
Apr. 10, 2020 (US) 63008268

(51) Int. Cl. G01B 11/25; G06T 17/20; G06T 7/521; G06T 7/593; G06T 7/60

(52) U.S. Cl. CPC G01B 11/2527; G06T 17/20; G06T 7/521; G06T 7/593; G06T 7/60; G06T 2207/10024; G06T 2207/30088; G06T 2207/30201

(57) ABSTRACT

Systems and methods for 3D image scanner for real-time, dynamic 3D surface imaging are disclosed. Embodiments of the present system and methods describe a system and method including a first and/or second, camera, and projector projecting structured light with fringe patterns onto a 3D object, and a processor configured to extract a phase map and a texture image from the image, and to calculate depth information from the phase map by the processor. Embodiments further describe methods and systems for determining an wrapped phase from the images using the Hilbert transformation, generating an absolute phase from the wrapped phase using the combination of a quality-guidance path following algorithm, a double wavelength phase unwrap algorithm, or a Markov Random field method, and generating a phase map from the absolute phase to determine depth information of the 3D object. The captured 3D geometric surfaces are registered, tracked using algorithms of conformal map, optimal transportation map and a Teichmuller map.

### CROSS-REFERENCE TO RELATED APPLICATION(S)

This application relates to and claims priority from U.S. Patent Application No. 63/008,268, filed on Apr. 10, 2020, the entire disclosure of which is incorporated herein by reference.

### GOVERNMENT FUNDING

This invention was made with government support under grant numbers CCF-0448399 and DMS-1418255 both awarded by the National Science Foundation. The government has certain rights in the invention.

### BACKGROUND

### A. Field of the Invention

The present invention relates generally to a method and system for a 3D image scanner for real-time, dynamic 3D surface imaging, using projected structured light to reconstruct depth and texture information of the object.

### B. Description of the Related Art

3D surface imaging is known in the art. Limitations in rendering quality, speed, and cost, however, currently limit the practical applications of 3D surface imaging.

Skin cancer is the most common cancer type in the United States, with over 5.5 million new cases diagnosed in 2019. Approximately one in five Americans develop skin cancer during their lifetime. Skin cancer rates have increased steadily, whereas rates of other cancers have declined over the same period. In particular, incidence rates of melanoma, the deadliest form of skin cancer, have more than doubled over the past 30 years. In a 2015 study comparing the cancer treatment costs for 2007-2011 to 2002-2006, CDC and National Cancer Institute researchers found that the average annual total cost of treating skin cancer increased by 126%, while the cost for other cancers went up 25%.

Skin cancer is highly treatable if detected early. Research has shown that sequential full-body scanning is an effective method for early detection of skin cancer, which can save lives, improve treatment outcomes, and reduce healthcare costs. Depending on the risk factors, it is recommended that patients be examined by dermatologists using full-body scans every three, six, or twelve months. The chance of early detection of skin cancer can be significantly improved only if the patient follows this guidance. Dermatologists can efficiently identify the high-risk spots in the skin and detect the changes of those spots in the sequential scans by comparing the corresponding images of the same patient from scans captured at different times. However, existing digital imaging products using 2D cameras are ineffective and cost-prohibitive in achieving these goals, resulting in low adoption by dermatologists and their patients.

Stereotactic body radiation therapy (SBRT) is a cancer treatment that administers very high doses to target the tumor. The goal is to deliver the highest possible dose to kill cancer while minimizing exposure to healthy organs. Because very high radiation doses could harm the patient if not accurately administered to cancer cells, SBRT requires that the patient being treated must be in the same position for every session and that the target area does not shift during treatment. As each session lasts from 30 minutes to an hour, this requirement poses a significant challenge to both the patient undergoing treatment and the clinicians responsible for constantly monitoring the patient's position to ensure patient safety.

There exist several technologies attempting to solve this issue. Unfortunately, each of them has short comings. Some cancer clinics set up video monitors in the treatment room and rely entirely on therapists to identify any live video movement. Therapists typically need to simultaneously monitor multiple patients under treatment, which divides their attention and further reduces this approach's effectiveness. X-ray has been used to check overall alignment by matching the bony anatomy. It results in increased radiation exposure of the patient and cannot be used for constant monitoring during the treatment. Radiation oncologists also use lasers to identify skin marks or tattoos placed on the patient's body. Studies have shown that, for patients with loose skin, skin marks or tattoos are unreliable in determining the body position. Besides, depending on the areas requiring treatment, patients may be resistant to permanent marks/tattoos placed on their skin due to concerns about cancer-related stigma or aesthetic appeal.

Optical surface imaging is becoming increasingly popular in radiotherapy for patient setup and monitoring. It provides real-time feedback on the patient's position concerning a reference surface captured during treatment planning, allowing clinicians to evaluate and readjust the patient's setup from within the room without using radiation or skin marks. However, optical surface imaging systems currently available in the market use 2D cameras to acquire images, which fail to capture the dynamic 3D surface changes of the human body in real-time and with high accuracy. Undetected alignment discrepancies, such as hip or upper body rotations (e.g., prostate or breast cancer treatment) or small movements of the area under treatment (e.g., brain tumor), could lead to increased patient dose, more extended setup time, and, most critically, harm to healthy organs.

The wide adoption of full-body sequential imaging requires practical solutions to two technical challenges. First, there is a need to capture the dynamic skin surface in real-time and with high accuracy. While high-resolution 2D cameras currently available on the market may capture the color and texture of the human skin, they cannot acquire depth information of the skin surface. The second pain point facing dermatologists is the labor-intensive and time-consuming process of accurately identifying suspicious lesions and examining changes of lesion characteristics using images from 2D camera systems. Because of the strong demand for dermatological care from their patients, most dermatologists do not have the time to examine the images produced by these imaging systems in a single scan, not to mention having to compare them with previous scans. Due to the 2D nature of these images, developing reliable image registration methods to precisely compare sequential images captured at different times remains a significant technical challenge.

An improved system and method for 3D image scanning could be beneficial in these and other applications where high speed and high quality 3D images can overcome the limitations of prior systems.

### SUMMARY

To address the drawbacks of conventional methods described in the background section, exemplary embodiments of the present system and methods provide a 3D scanner method and system for real-time, dynamic 3D surface imaging. The system and method enable automated surface registration and allow the measurement and alignment of 3D objects with improved accuracy.

Embodiments of the systems and methods described herein provide a system and method for 3D facial scanning. The system and method is a 3D facial scanning system with high speed and high resolution that captures both geometry and texture with dynamic expressions. The system and method is portable and easy to use, with accurate and robust geometric processing tools. The system and method is suitable for facial expression tracking in movies and games, VR/AR content generation, is useful for melanoma detection, orthodontics and plastic surgery.

The system and method includes both hardware and software for medical fields and can be useful for are dermatologists, dentists, plastic surgeon, etc. The system and method may also be used for security to be used by government officials or police. The system and method may be used for facial expression capture systems, movie/game studies, VR/AR makers, digital artists.

The system and method is based on structured light and includes a digital camera system, a digital projector and a computer programmed to operate the system in a novel manner. The projector projects fringe patterns onto the 3D object, the camera system captures the image of the object illuminated by the structured light. Each iso-phase line in the projected fringe pattern is distorted to a curve on the 3D object, and projected to a curve on the camera image. From the distortion of the phase lines, and the relative geometric relation between the projector, camera and the world, the computational algorithm processes the camera images to reconstruct the 3D geometry and the texture.

The captured fringe images are processed, to extract the phase map and the texture image. From the phase map, the algorithm can calculate the depth information, and recover the geometry of the object. This 3D scanning system can capture facial surfaces, including surfaces with dynamic expression, with high resolution and high speed.

The system and method allows for high speed 3D surface image capture, which is beneficial in a number of applications including scanning faces with dynamic expression. The system and method utilizes geometric processing software that is more accurate and robust than conventional systems

Exemplary embodiments provide a computer implemented system and method for three dimensional scanning. The system may include a projector configured to project structured light onto a three-dimensional object. A gray-scale camera may be provided and configured to capture fringe image of the object. The system may further provide a color camera configured to capture color image of the object. A processor is preferably configured to process the fringe image to extract a phase map and a texture image, to calculate depth information from the phase map, and to perform 3D surface reconstruction based on the depth information and texture image.

According to an exemplary embodiments of the present system, the image is captured by a first camera for capturing a fringe image of the three-dimensional object, and a second camera for capturing a color texture image of the object. Exposure cycles of both the first and second cameras are preferably synchronized. In one example, the first camera is triggered to capture an image on each off cycle, and the second camera is triggered to capture an image every three of cycles.

According to further exemplary embodiments, the structured light is comprised of sinusoidal fringe patterns, each fringe pattern having one channel; the fringe patterns are defocused patterns; and the fringe patterns have less than 8-bit quality.

According to further exemplary embodiments, the processor generates the phase map based on consideration of an intensity bias (ambient) component of the fringe image, a modulation component of the fringe image, and a wrapped phase of the fringe image; the processor determines an unwrapped phase based on the wrapped phase, using a single image with the Hilbert Transformation to enable, for example, the rendition of smooth geometric surfaces, such as the rendition of aa human face. The processor may determine the unwrapped phase using a quality-guidance path following algorithm by repeating the following steps: selecting a first pixel; determining the wrapped phase, Φ(x,y), of the first pixel; placing pixels neighboring the first pixel into a priority queue; selecting a second pixel from the priority queue with the highest quality. The processor can determine the unwrapped phase using a double wavelength phase unwrap algorithm wherein the projector projects a first fringe pattern with a first wavelength, λ₁, and a second fringe pattern with a second wavelength λ₂ and, λ₁<λ₂ and the processor determines the unwrapped phase based on the two wrapped phases of each wave length. Further, the processor determines the unwrapped phase using a Markov random field method. Furthermore, the double wave length phase unwrap algorithm may be combined with the Markov random field method to improve the quality of the unwrapped phase determination.

According to further exemplary embodiments, the texture image is used to find facial landmarks and to perform facial feature extraction by the processor using deep learning based computer vision algorithms, such as by using the single shot detector (SSD) structure network for face detection and facial landmarks. A quality map and a mask of a facial skin area are generated by the texture image, and the quality map and mask inputted into a phase unwrapping algorithm by the processor to determine an unwrapped phase.

According to further exemplary embodiments, the processor transforms world coordinates of a point, to camera coordinates. The processor may transform the camera coordinates to camera projective coordinates. The processor may further transform. the camera projective coordinates to distorted camera projective coordinates and transform the distorted camera projective coordinates to camera image coordinates.

According to further exemplary embodiments, extrinsic and intrinsic parameters of the camera are calibrated using a target board. The target board may comprise a star-planet pattern containing a plurality of larger circular stars, each surrounded by smaller circular planets, wherein each planet is one of a solid or a hollow circle. The extrinsic and intrinsic parameters of the camera can be calibrated as an optimization process. In one example, the extrinsic and intrinsic parameters of camera are calibrated using Zhang's algorithm and a gradient descend algorithm. The calibration of the extrinsic and intrinsic parameters of the camera may take into consideration the position of the centers of each of the plurality of stars as a variable in the optimization process.

According to further exemplary embodiments, distortion parameters are determined by the processor using Heikkil's formula.

According to further exemplary embodiments, at least one point cloud is generated based on the depth information by the processor and the point cloud is processed by the processor to form a high-quality triangle mesh. The processor can further perform conformal geometry methods for image and shape analysis and real-time tracking applications. Ambient, modulation and projector parameters may be used to estimate surface normal information in the process of generating at least one point cloud. A persistent homology algorithm may also be used to compute handle loops and tunnel loops for topological denoise. Further, conformal parameterization is performed and Delaunay triangulation and/or centroidal Voronoi tessellation are applied to the output of the conformal parametrization to generate the high quality triangle mesh.

According to yet further exemplary embodiments, an image is captured from two different viewing angles to obtain stereoscopic depth information, wherein the processor uses a Markov random field method to both i.) determine an absolute phase of each pixel to determine depth information from the fringe patterns, and ii.) and to perform a stereo-matching method to acquire the stereoscopic depth information. Further, the depth information and the stereoscopic depth information are used as an input into the generation of at least one point cloud.

According to further exemplary embodiments, first fringe images are captured at a first time and used to perform a first 3D surface reconstruction by the processor, second fringe images are captured at a second time and used to perform a second 3D reconstruction by the processor, and the first and second 3D reconstructions are registered for comparison. The second 3D reconstruction is registered to the first 3D reconstruction using conformal geometry. The second 3D reconstruction is registered to the first 3D reconstruction by mapping the surfaces to a plane and comparing the resulting planar images. The comparison is determined with at least one optimal transportation map. A Fast Fourier Transformation (FFT) is applied to the at least one optimal transportation map. Textural features and the geometric features are extracted from the first and second fringe images. The comparison uses Teichmuller maps to enforce the alignments of features extracted from the first and second fringe images and to reduce distortion.

According to further exemplary embodiments, at least one prism is used to alter to path of one of the projector or the camera.

According to further exemplary embodiments, a phase-height map is modeled as a polynomial function at each pixel of the camera, and coefficients of the polynomial are estimated in a camera-projector calibration process using an optimization algorithm. Further, a polynomial representation of the phase-height is stored as a configuration file.

These and other advantages will be described further in the detailed description below.

### BRIEF DESCRIPTION OF THE DRAWINGS

For a more complete understand of the present invention, the objects and advantages thereof, reference is now made to the following descriptions taken in connection with the accompanying drawings in which:

FIG. 1 is a simplified flow chart illustrating an example of the high level operation of the present systems and methods of 3D scanning.

FIG. 2 is a simplified diagram depicting a high-level system layout for an exemplary embodiment of the 3D scanning system.

FIG. 3 depicts an interior layout of the illustrative scanning system for an exemplary embodiment of the present system.

FIG. 4 depicts a side perspective of an interior layout of an illustrative scanning system for an exemplary embodiment of the present system.

FIG. 5 depicts a front view of a container of an illustrative scanner system facing an object to be scanned for an exemplary embodiment of the present system.

FIG. 6 is a drawing which schematically illustrates a light path of the illustrative scanner system for an exemplary embodiment of the present system.

FIG. 7 depicts a bottom view of a container of the illustrative scanning system situated to face an object to be scanned for an exemplary embodiment of the present system.

FIG. 8 depicts an example of fringe patterns that may projected in exemplary embodiments of the present system.

FIG. 9 is a timing diagram illustrating an example of the synchronization of the exposure time of the first camera and the second camera in exemplary embodiments of the present system.

FIG. 10 is a timing diagram illustrating an example of the synchronization of the first camera, second camera, and projector in exemplary embodiments of the present system.

FIG. 11 illustrates a coordinate system of the camera used in exemplary embodiments of the present systems and methods for processing images.

FIGS. 12A-12C depict an example of a fringe image, phase map, and a gray-scale texture image generated in accordance with exemplary embodiments.

FIGS. 13A-13C depict an example of three raw fringe images with a fringe pattern wavelength of λ₁=45 that may be used to recover one frame of a 3D surface.

FIGS. 14A-14C depict an example of three raw fringe images with a fringe pattern wavelength of λ₂=48 that may be used to recover one frame of a 3D surface.

FIGS. 15A-15C depict an example of an ambient, modulation, and texture image generated from the raw fringe images with a fringe pattern wavelength of λ₁=45;

FIG. 15D-16F depict an example of an ambient, modulation, and texture image generated from raw fringe images with a fringe pattern wavelength of wavelength λ₂=48.

FIGS. 16A-16H depict various images generated during stages of the phase unwrapping processes in exemplary embodiments of the present system and methods.

FIGS. 17A-17C depict an example of images generated in accordance of exemplary embodiments of the present system and methods including a.) the wrapped phase Φ₁ with λ₁=45, b.) wrapped phase Φ₂ with 2=48 and c.) the unwrapped (absolute) phase using a double wave-length phase unwrapping algorithm.

FIGS. 18A-18C depict an example of reconstructed 3G geometry, geometry with a gray scale texture mapping, and geometry with a color texture mapping, respectively, generated in accordance with exemplary embodiments of the present system and methods.

FIG. 19 depicts an example of a reconstructed facial surface with texture mapping viewed from different angles generated in in accordance of exemplary embodiments of the present system and methods.

FIG. 20A-20C depict examples of face detection and facial landmark extraction from a color texture image captured using an ensemble of regression trees (ERT) algorithm in accordance of exemplary embodiments of the present system and methods.

FIG. 21 depicts an example of geometric surfaces with color texture generated in in accordance of exemplary embodiments of the present system and methods.

FIGS. 22A-22C depict an example of the detection of a facial region of a person using SSD structure network, the finding of facial landmarks, and the performance of facial feature extraction using ensemble of regression trees (ERT) algorithm in computer vision, respectively, in accordance of exemplary embodiments of the present system and methods.

FIG. 23A-23C depict examples of geometric surfaces generated during the reconstruction of the facial skin surface using the phase information and processed by a hole-fill algorithm as described in exemplary embodiments of the present system and methods.

FIG. 24 depicts a flow chart of a 3D acquisition process of an exemplary embodiment of the present system and methods.

FIG. 25 illustrates the mathematical model of a pinhole camera as described in exemplary embodiments of the present system and methods.

FIG. 26 depicts an example of a target board used for calibration in exemplary embodiments of the present system and methods.

FIG. 27 illustrates the imaging relationship between the camera and projector in exemplary embodiments of the present system and methods.

FIG. 28 depicts a diagram of an exemplary system used for phase-height map calibration.

FIG. 29 depicts a flow chart of a camera calibration and point cloud generation process of an exemplary embodiment of the present system and methods.

FIG. 30 depicts a flow chart showing an exemplary surface reconstruction process in an exemplary embodiment of the present system and methods.

FIG. 31 depicts a flow chart showing an exemplary shape analysis process in an exemplary embodiment of the present system and methods.

### DETAILED DESCRIPTION

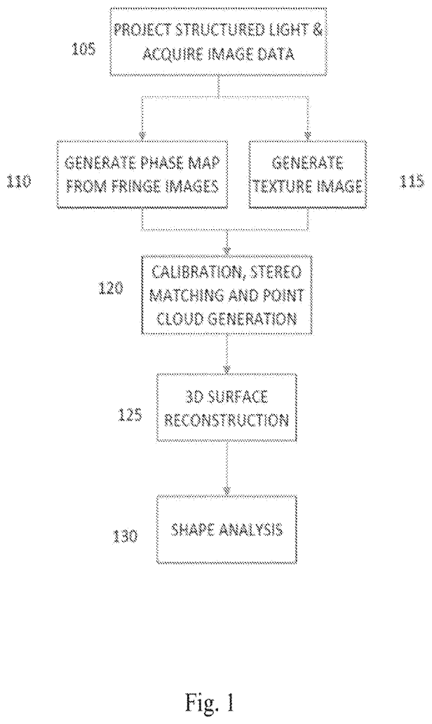

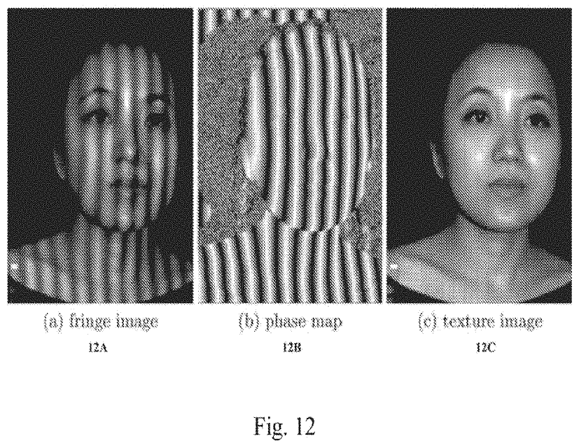

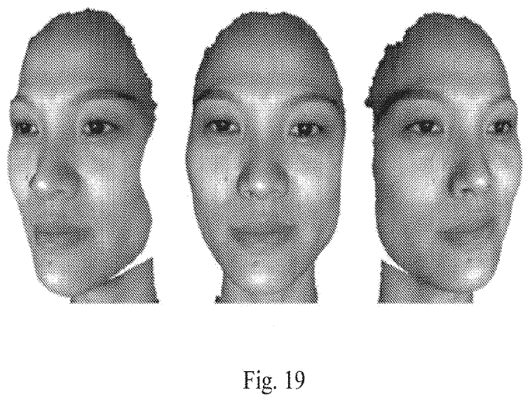

The present systems and methods for efficient high speed 3D image scanning are generally illustrated at a high level in the flow chart of FIG. 1. In block 105, the system projects structured light onto a 3D subject and acquires image data from the illuminated object. The acquired image data will typically include at least one gray scale fringe image and preferably a color image. From the acquired image data, a phase map is generated in block 110 and a texture image is generated in block 115. This is illustrated, for example, in the images in FIG. 12, wherein FIG. 12A illustrates an exemplary fringe image, FIG. 12B illustrates an exemplary phase map, and FIG. 12C illustrates an exemplary gray-scale texture image. Returning to FIG. 1, in block 120 the phase map and texture image, along with calibration data for the camera system and projector system, can be used to generate point clouds with texture representing the object in a 3d space. From the generated point clouds, surface reconstruction can be performed to generate a surface mesh in block 125. This is shown, for example, in the images in FIG. 19, which depicts an example of a reconstructed facial surface with texture mapping viewed from different angles generated in in accordance of exemplary embodiments of the present systems and methods. In FIG. 1, in block 130 shape analysis, including dynamic shape tracking, image analysis and real-time tracking, can be applied as appropriate for the desired application. Each of these processes is described in further detail below.

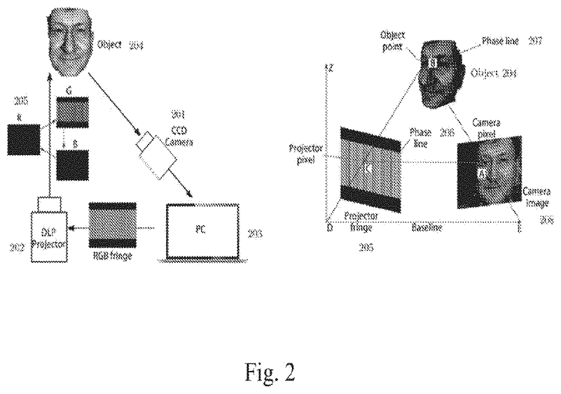

Hardware. FIG. 2 illustrates a simplified hardware layout for an exemplary embodiment of the 3D scanning system based on structured light. The system consists of a digital camera system 201, a digital projector 202 and a computer, 203. The projector 202 projects structured light, such as fringe patterns 205, onto a 3D object 204, the camera system 201 captures image of the object illuminated by the fringe patterns 205. The projector may generate three different color channels (red, green and blue) in each projection cycle as illustrated in 205. As will be described in further detail, although illustrated as a single camera in FIG. 2, the camera system 201 may include a plurality of cameras with varying acquisition attributes and spatial orientation. For example, the camera system may include one gray scale camera and one color camera, 2 gray scale cameras for stereoscopic imaging, and various combinations thereof.

Each of the iso-phase lines 206 in the fringe patterns 205 are distorted to a curve on the 3D object 204, as shown in reference 207, and projected to a curve on the camera image 208. From the distortion of the iso-phase lines, and the relative geometric relation between the projector 202, camera 201, and the world, the computer 203 via a computational algorithm, as described in more detail below herein, digitally processes the camera images to reconstruct the 3D geometry and the texture of the object.

The equipment and the settings thereof as described herein to be used in exemplary embodiments is merely illustrative, and is not meant to be exhaustive. Other permutations of equipment and equipment settings may be substituted for the ones described herein as will be apparent to those of ordinary skill in the art. By way of example, exemplary embodiments of the present systems and methods may use a DLP LightCrafter 4500 projector for casting fringe patterns, and a Basler acA640-750 um camera for capturing the fringe patterns. The camera may be, for example, a gray camera with an acquisition frame rate of at least 180 frames per second (fps) with a resolution of 640×480 with a maximum frame rate of 750 fps. The pixel size of the camera may be, for example, 4.8 μm×4.8 μm. The depth precision may be, for example, 0.2 mm or better. Other types of projectors and cameras may be used as will be apparent to those of ordinary skill in the art, including other types of digital micro mirror device (DMD). The projector may use a visible light source, or may use infrared light to avoid disturbing the subjects being imaged (e.g., patients in medical applications), or may use another type of electromagnetic radiation. Exemplary embodiments of the present systems and methods may use, for example, IEEE 1394 PCIe card for the multi-camera system and USB 3.0 for the single-camera system to ensure the bandwidth for data transportation. Moreover, exemplary embodiments of the present systems and methods may use a solid-state disk to guarantee the disk IO speed and capacity.

The camera used in exemplary embodiments may be triggered every OFF pulse when the projector casts a fringe pattern. In exemplary embodiments an 8-bit fringe pattern images may advantageously be used. In such a case, exemplary embodiments of the present systems and methods may capture as many as 40 3D fps. Exemplary embodiments may advantageously use 4-bit patterns for capturing moving objects. In such a case, exemplary embodiments of the present systems and methods, may capture as many as 200 3D fps.

Exemplary embodiments may advantageously use a second (color) camera to enable color texture or vertex color in a 3D mesh which is generated. The second camera need not be as fast as the first camera, which may be a monochrome camera, since only one texture image is needed to generate a three dimensional mesh—which, as described in the exemplary embodiments herein, need only be generated using three fringed gray-scale images. The second camera is preferably calibrated with the scanning system. In exemplary embodiments of the present systems and methods may use, for example, a Basler acA1300-200uc as the second camera with a Computar M1614-MP2 F1.4 f16 mm lens.

Exemplary embodiments of the present systems and methods may employ a second gray scale camera to combine stereo-vision and structured light. The structured light may be based on the double wavelength phase-shifting method from interferometry. The stereo-vision matches two images captured from different viewing angles to obtain the depth, which is much faster (at least three times) than structured light but with lower accuracy. Structured light encodes the phase information by the intensity and recovers the depth from the phase information, which is slower but much more accurate than stereo-vision. Conventional 3D acquisition methods use either stereo-vision or structured light. Leveraging the power of these two methods allows the scanner described in exemplary embodiments to improve both speed and accuracy.

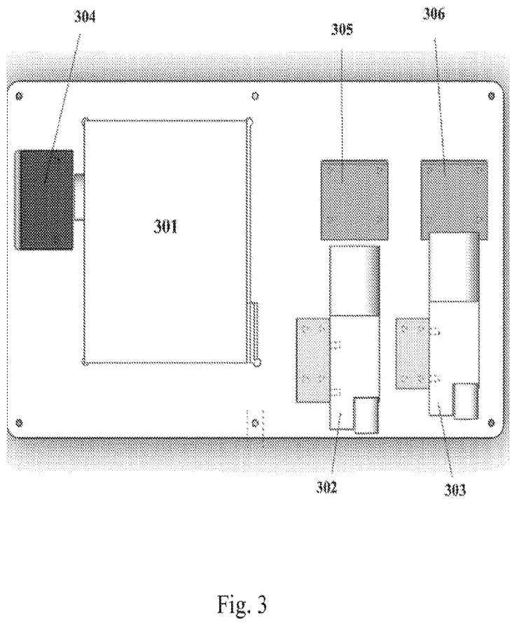

Exemplary embodiments of the present systems and methods may further utilize one or more prisms to change the optical path for one or both of the cameras and/or the projector in order to reduce the thickness of a device containing the components used to implement exemplary embodiments of the present systems and methods. Prisms may advantageously be used to make a physically compact scanner system, which may incorporate a variety of the components used in exemplary embodiments of the present systems and methods described herein (e.g. the projector and cameras). An illustrative scanner system is illustrated with reference to FIGS. 3-7. FIG. 3 depicts an interior layout of the illustrative scanning system. 301 refers to a projector, 302 refers to a color camera, 303 refers to a grayscale camera, 304 refers to a prism modifying light emanating from the projector 301, 305 refers to a prism which alters light before being captured by the color camera 302, and 306 refers to a prism which alters light before being captured by the color camera 305. In this example, prisms 305 and 306 are 45°. The optical axis of prism 304 is spaced 186 mm from that of prism 305 and prism 305 is spaced 60 mm from prism 306. Although these dimensions may be altered for a given application, the spacing of the components must be known for calibration and image reconstruction as described further herein.

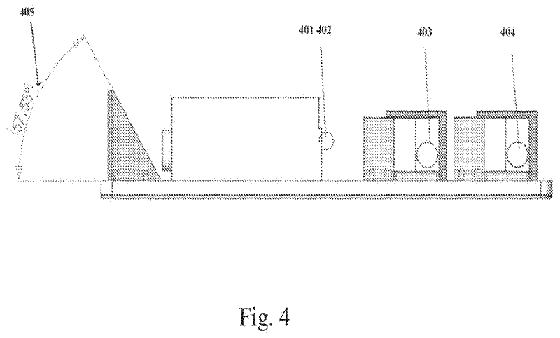

FIG. 4 depicts a side perspective of the interior layout of the illustrative scanning system. 401 refers to the power supply connections for the projector, 402 refers to an interface for the projector (e.g., output trigger), 403 refers to an interface for the color camera (e.g., input trigger), 404 refers to an interface for the grayscale camera (e.g., input trigger), and 405 is refers to a slope angle of the prism of the projector (304 depicted in FIG. 3), which in FIG. 4, is given at 57.53°. The slope angle of the projector may is merely illustrative, other slope angles of the prism of the projector may be used.

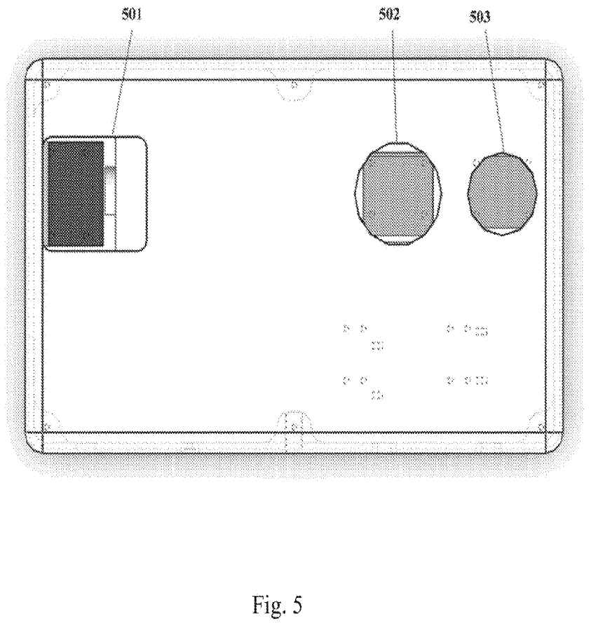

FIG. 5 depicts a front view of a container of the illustrative scanner system facing an object to be scanned. 501 refers to an opening in the container enabling fringe images to be projected from the projector 301 onto the object, 502 is an opening in the container enabling light reflecting off a surface of the object to be captured by the color camera 302, and 503 is an opening in the container enabling light reflecting off a surface of the object to be captured by the grayscale camera 303.

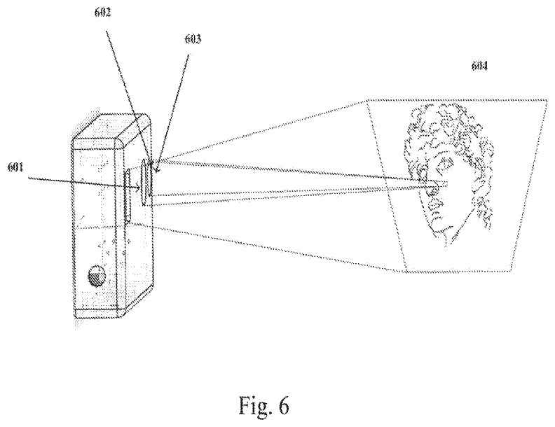

FIG. 6 is a schematic diagram which illustrates a light path of the illustrative scanner system. 601 refers to fringe images generated by the projector 301 which will pass through the prism of the projector 304, then pass through opening 501, and illuminate the object 604. 602 refers to the capture of light by the color camera which reflects off of the surface of the object 604 and travels through opening 502 and the prism of the color camera 305. 603 refers to the capture of light by the grayscale camera 303 which reflects off of the surface of the object 604 and travels through opening 503 and the prism of the grayscale camera 303.

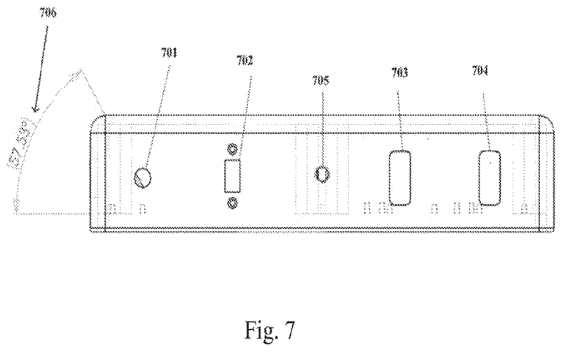

FIG. 7 depicts bottom view of the container of the illustrative scanning system situated to face an object to be scanned. 701 refers to a power supply connection for the projector 301, 702 refers to a USB interface connection to the projector 301, 703 refers to a I/O connection to the color camera 303, 704 refers a USB I/O connection to the grayscale camera 302, 705 refers to a screw mount for mounting the illustrative scanning system to a fixture or surface, and 706 refers to the slope angle of the prism 304 of the projector 301, which in FIG. 7, is depicted as 57.53°. As already indicated, the slope angle depicted in the illustrative scanning system is merely illustrative and other slope angles of the prism of the projector may be used.

The scanner system illustrated in FIGS. 3-7 can be expanded by duplication of the system and time sharing the systems during image acquisition. In this regard, there would be a first scanning system with a projector 301, color camera 302, and gray scale camera 303, along with the corresponding optical components and a second scanning system with a projector 301′, color camera 302′, and gray scale camera 303′, along with the corresponding optical components. The processor would then use the first and second scanning systems in a time-shared manner to increase the acquisition capabilities of the system. Exemplary embodiments may project a single wavelength, three-phase shifting fringe pattern onto objects to capture 3D information.

In exemplary embodiments of the present systems and methods the scanner may project sinusoidal patterns (i.e. fringe patterns) on the target surface in a very short period of time. FIG. 8 depicts an example of fringe patterns that may projected. The color image has three channels (Red, Green, and Blue), and each channel represents one fringe pattern. It is noted that various orientations of the fringe pattern, e.g., vertical or horizontal, may be used depending on the dominant geometry of the object being imaged.

The patterns may be generated with, for example, Digital Fringe Generation Technique. For example, using a three-step phase shifting algorithm, each fringe pattern may be generated as a 8-bit grayscale image, the patterns can be mathematically represented as:

$${I}_{1} ( i , j ) = \frac{255}{2} [ 1 + cos ( \frac{2 π j}{λ} - \frac{2 π}{3} ) ] , \\ {I}_{2} ( i , j ) = \frac{255}{2} [ 1 + cos ( \frac{2 π j}{λ} ) ] , \\ {I}_{3} ( i , j ) = \frac{255}{2} [ 1 + cos ( \frac{2 π j}{λ} + \frac{2 π}{3} ) ] . \qquad ( 1 )$$

In these equations, λ denotes the wavelength, the number of pixels per fringe period (i.e. the fringe pitch), and (i,j) denotes the pixel index. For example, if λ=45, that means one period of the fringe occupies 45 pixels of the projector screen. This is typically a physical attribute of the projector screen.

A DLP projector, for example, may advantageously be employed (as opposed to, for example a LCD or LCoS projector) to project fringe patterns onto the target surface. A DLP projector generates three different color channels (red, green and blue) in each projection cycle, such that three DFP images can be combined to one color image with each pattern saved in one channel, hence the projection speed is tripled. In practice, the DLP projector may have a relatively larger phase error while using the red channel, which may be caused by a longer off time for the red channel. The camera is triggered on each OFF pulse of the projector: if the red channel has a longer off time than the blue and green channels, more ambient light will enter the camera, lowering the signal to noise ratio (SNR) and the captured phase quality may be affected. To solve this problem, exemplary embodiments of the present systems and methods may utilize defocused patterns instead of traditional digital fringe projection (DFP), thus significantly improving the phase quality. Moreover, the use of a DLP projector provides an alternative solution and enables a trade of a slight reconstruction quality loss for a significant improvement in scanning speed. The present systems and methods may use fringe patterns projections with lower quality (e.g., 4-bit), so that all 6 patterns can be saved in one color image, and the systems described in the exemplary embodiments may speed up for decreased caching and projecting time. In practice, the use of 4-bit fringe patterns may enable the system to be 5-6 times faster than using 8-bit fringe patterns.

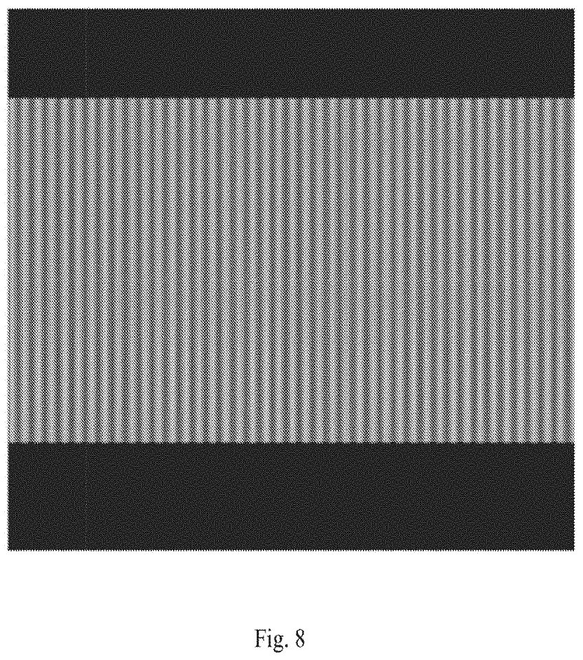

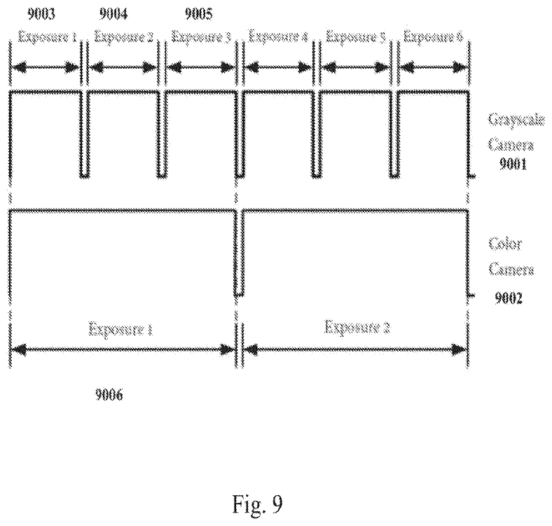

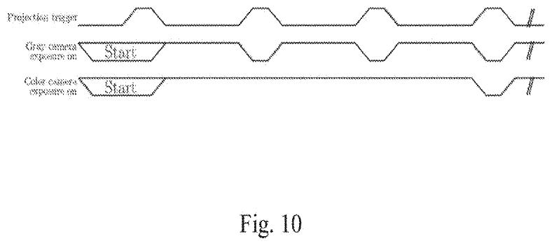

Camera Synchronization. As discussed, in order to enable color texture or vertex color to be included in the generated 3D mesh in the system of exemplary embodiments of the present systems and methods, the scanning system may use a color camera in addition to the gray scale camera(s). To eliminate interference from the fringe strikes, the exposure time of the second camera should cover a complete cycle of the sinusoidal patterns projected onto the object. Exemplary embodiments may advantageously use a three-step phase shifting method. In one example, the color camera is triggered every three OFF pulses, such that the exposure time of the second camera is three times longer than the exposure time of the first camera (which may be a grayscale camera.) The color and grayscale cameras may both be triggered by the same projector, and thus the exposure cycles of the cameras may be synchronized automatically. FIG. 9 illustrates the synchronization of the exposure time of the first camera (e.g. a “grayscale camera”), 9001, with the second camera (e.g. the “color camera”), 9002 in exemplary embodiments of the present systems and methods. For every three times the first camera is triggered (9003, 9004, 9005), the second camera is triggered once (9006). FIG. 10 illustrates an example of the synchronization of the first camera, second camera, and projector in exemplary embodiments of the present systems and methods.

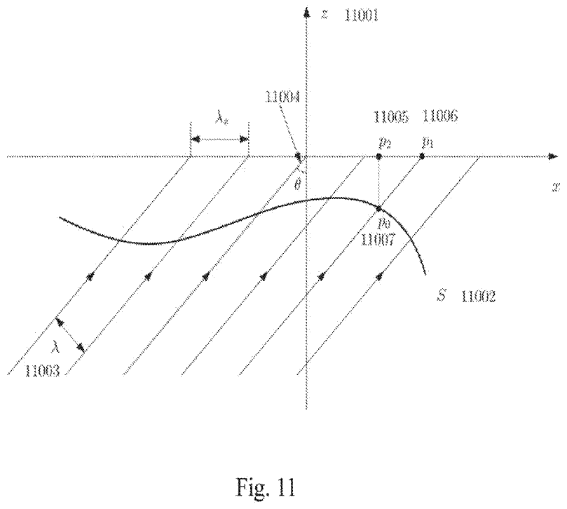

Geometry vs. Phase. FIG. 11 graphically illustrates the coordinate system of the camera, which exemplary embodiments may use in processing images. In the camera coordinate system, z, 11001, denotes the depth, S, 11002, denotes the surface of the object. The surface S, 11002 is represented as the depth function:

z(x,y)=h(x,y), (2)

where (x, y) denotes the spatial coordinates of the camera image. In exemplary, the sinusoidal fringe pattern is projected onto the surface, the spatial wavelength of the fringe pattern is λ, 11003. The angle between the optical axis of the projector and the optical axis of the camera (z-axis) is θ, 11004, then the wavelength of the projected fringe pattern on the plane z=U is λₓ, which is defined as:

$${λ}_{x} = \frac{λ}{cos θ} . \qquad ( 3 )$$

If p₀ 1107 is fixed on the surface S 1102, p₀ and p₂ 11005 share the same (x,y) coordinates, p₁ 1006 and p₀ are on the same phase line, p₁=(x₁,y₁,0), p₂=(x₂,y₂,0), the depth of p₀ is h(x₂,y₂), then the following relationship may be derived:

Δx=x₂−x₁,Δφ=φ₂−φ₁,

where φₖ is the absolute phase of pₖ, k=1, 2. Then the following equations can be derived:

$$Δ φ = {φ}_{2} - {φ}_{1} = 2 π \frac{Δ x}{{λ}_{x}} = 2 π cos θ \frac{Δ x}{λ} \\ and \\ h ( x , y ) = Δ x cot θ = \frac{λ}{2 π sin θ} Δ φ . \qquad ( 4 )$$

Therefore, present systems and methods may compute the depth information h(x, y) from the phase Δφ.

Phase Shifting: Fringe Images. Exemplary embodiments of the present systems and methods may use a phase shifting method to reconstruct 3D information from fringe images captured by the camera. Exemplary embodiments may further enable the processing of raw fringe images captured by the camera, to extract phase maps, and texture images. FIG. 12A depicts an exemplary fringe image, FIG. 12B depicts an exemplary phase map, and FIG. 12C depicts an exemplary gray-scale texture image. From the phase map, the algorithm as described herein may calculate depth information, and recover geometric coordinates of the object.

The fringe images are modeled using the fundamental formula as follows:

I(x,y)=I′(x,y)+I″(x,y)cos[φ(x,y)], (5)

where x and y are spatial coordinates, I′(x, y) is the intensity bias, the ambient light as usual, I″(x, y) is half of the peak-to-valley intensity modulation, which is the intensity of the light from the projector, and φ(x, y) is the phase which controls the temporal phase difference of this sinusoidal variation related to the reference wave front. If x and y are fixed, there are three unknowns to solve in Eqn. (5). For each pixel on the fringe images, the difference of I(x, y) is directly indicated by the gray-scale value, so a minimum number of three fringe images is sufficient to recover one 3D frame since there are three unknowns in Eqn. (5). The speed and resolution of the 3D frame may be fully controlled by the speed and resolution of the camera and projector.

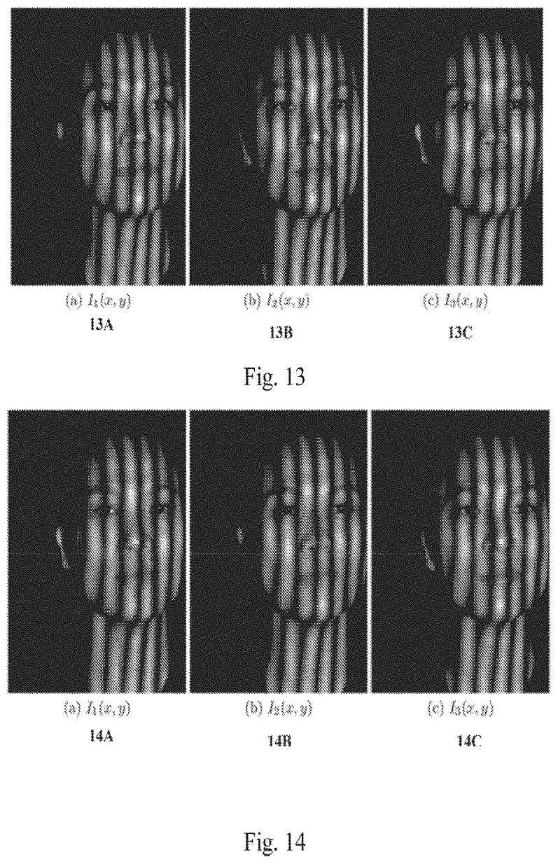

In other words, the target object should be near static since x and y are fixed, that means either the object is not moving or the projector and camera have very high frame rates. In practice, exemplary embodiments may use some denoising and pixel tracking method to lower the influence of moving objects. FIGS. 13A-13C depict an example of three raw fringe images with a fringe pattern wavelength of λ₁=45 that may be used to recover one 3D frame of a 3D surface as described above, and FIGS. 14A-C depict an example of three raw fringe images with a fringe pattern wavelength of λ₂=48 that may be used to recover one 3D frame of a 3D surface as described above.

Ambient, Modulation and Texture. Exemplary embodiments of the present systems and methods may use a three-step phase-shifting algorithm and two different wavelengths to unwrap the absolute phase.

If the phase shift is given as δ=2π/3, a bundle of three fringe images may be defined as:

I₁(x,y)=I′(x,y)+I″(x,y)cos[Φ(x,y)−2π/3],

I₂(x,y)=I′(x,y)+I″(x,y)cos[Φ(x,y)],

I₃(x,y)=I′(x,y)+I″(x,y)cos[Φ(x,y)+2π/3], (6)

I₁, I₂, I₃ are referred to as I₁(x, y), I₂(x, y), I₃(x, y) for convenience. Φ(x, y) can be solved as:

$$Φ ( x , y ) = {tan}^{- 1} [ \frac{\sqrt{3} ( {I}_{1} - {I}_{3 )}}{2 {I}_{2} - {I}_{1} - {I}_{3}} ] , \qquad ( 7 )$$

the average intensity may be computed as:

$${I}^{′} ( x , y ) = \frac{{I}_{1} + {I}_{2} + {I}_{3}}{3} \qquad ( 8 )$$

and the data modulation may be computed as:

$${I}^{″} ( x , y ) = \frac{\sqrt{3 {( {I}_{1} - {I}_{3} )}^{2} + {( 2 {I}_{2} - {I}_{1} - {I}_{3} )}^{2}}}{3} . \qquad ( 9 )$$

Finally, the texture without fringe stripes may be generated as:

Iₜ(x,y)=I′(x,y)+I″(x,y). (10)

FIGS. 15A-15C depict an example of an ambient, modulation, and texture image generated from the raw fringe images with a fringe pattern wavelength of λ₁=45, and FIGS. 15 D-15F depict an example of an ambient, modulation, and texture image generated from raw fringe images with a fringe pattern wavelength of wavelength λ₂=48.

Hilbert Transformation. The raw image minus the ambient component may be computed by:

Iₖ(x,y)−I′(x,=I″(x,y)cos[Φ(x,y)+2kπ/3].

After using a Hilbert transformation, the following equation is obtained:

[symbol]

(Iₖ−I′)(x,y)=I″(x,y)sin[Φ(x,y)+2kπ/3].

Therefore, the wrapped phase may be recovered from a single image using the following computation:

$$Φ ( x , y ) = {tan}^{- 1} \frac{ℋ ( {I}_{k} - {I}^{′} ) ( x , y )}{{I}_{k} ( x , y ) - {I}^{′} ( x , y )} - \frac{2 k π}{3} .$$

Conventional phase shifting algorithms requires at least 3 images to compute the wrapped phase. By using Hilbert transformation, the present methods may use only a single image to compute the phase. This increases the scanning speed by 3 times, and greatly improves the robustness of the described system.

Phase Unwrapping. The wrapped phase may be recovered to the absolute phase using the assumption that the surface is continuous. As described herein, the exemplary embodiments may use a quality-guided path following phase unwrapping algorithm for dynamic surfaces with lower curvature and high-speed acquisition. Exemplary embodiments of the present systems and methods may also use a double wavelength phase unwrapping algorithm for surfaces with complicated geometries and slow deformations. Exemplary embodiments may further unwrap the wrapped phase using an algorithm based on Markov random field (MRF), which advantageously may be employed for capturing noisy shapes, which require intensive computation. MRF algorithms may implement parallel optimization algorithms (such as graph min cut/max flow) on GPUs for this purpose. For a large field view, the system may further use double camera systems with synchronization. In such a case, both structured light and stereo matching algorithms may be implemented to fuse the geometric and textural data. For static shapes, exemplary embodiments of the invention may use multi-level Gray codes.

Quality-Guidance Path Following. Exemplary embodiments may utilize quality-guidance path following algorithms to find facial skin area in a face detection and feature extraction step, and will define a mask. The modulation calculated as previously described indicates the quality of each pixel, which may be used to define a quality map.

In the quality-guidance path algorithm used in exemplary embodiments of the present systems and methods, the algorithm may choose a seed pixel, use its wrapped phase as the absolute phase, and put all its neighboring pixels within the mask in a priority queue. At each step, the algorithm may choose the pixel in the queue with the highest quality, find its neighbors, and unwrap their phases to absolute phases, and then put its neighbors in the queue. The algorithm may repeat this process, until all the pixels within the mask are unwrapped.

Double Wavelength. Exemplary embodiments of the present systems and methods may also utilize a double wavelength algorithm to unwrap the wrapped phase. The phase shifting method described is within the range (−π, π), that means if the wavelength of the fringe pattern is not large enough, the phase on the object surface will suffer from discontinuities with 2kπ. In exemplary embodiments of the invention implementing a double wavelength algorithm, raw images of an object may be captured with two different fringe patterns having different wavelengths (λ₁ and λ₂, λ₁<λ₂) instead of one very wide fringe pattern. The different wavelengths may be used by the double wave length algorithm to measure the same object surface, the two phase maps are defined by:

$${Φ}_{1} = Φ ( x , y ) = \frac{2 π h ( x , y )}{{λ}_{1}} , \qquad ( 11 )$$

$${Φ}_{2} = Φ ( x , y ) = \frac{2 π h ( x , y )}{{λ}_{2}} . \qquad ( 12 )$$

The difference between the two phase maps is represented by:

$${ΔΦ}_{12} = {Φ}_{1} - {Φ}_{2} - [ \frac{2 π \cdot h ( x , y )}{{λ}_{12}^{eq}} ] , \qquad ( 13 )$$

$${λ}_{12}^{eq} = \frac{{λ}_{1} {λ}_{2}}{\vert {λ}_{2} - {λ}_{1} \vert} \qquad ( 14 )$$

is the equivalent wavelength between λ₁ and λ₂, and is large enough to unwrap the absolute phase ϕ by

ϕ=ΔΦ₁₂ mod 2π. (15)

So if λ₁₂^{eq} is large enough to cover the whole range of image, the modulus operator does not change the phase, thus the generated phase is the same as unwrapped phase. This method is faster, but it increases noise compared to a quality-guidance path following algorithm.

Markov random field method. Exemplary embodiments may unify stereo-matching algorithms and phase unwrapping algorithm using the Markov random field method. In the phase-shifting structured light method described in the exemplary embodiments of the present systems and methods, the absolute phase is proportional to the height information. Only wrapped phase information can be obtained from the images, which is the absolution phase modulus 2π. The difference is an integer number of 2π, and the integer is called wrap count. The process of recovering the absolution phase from the wrapped phase is a crucial step in the pipeline. The Markov random field method models each pixel's wrap count as an integer-valued random variable and all the wrap counts of each image pixel may form a random field. Each random variable is affected by its neighbors. Phase unwrapping is equivalent to optimizing the random field's total energy, which can be achieved by translating the problem to a max flow of a graph and then solved by max flow/min cut algorithm. The graph cut method for phase unwrapping is more robust to noises and produces higher fidelity than other techniques, such as path following, double wavelength, etc. In contrast, Markov random field method can also provide a robust stereo-matching method, which searches for the best-matched pixels along the epipolar lines. Hence, the present systems and methods may use one efficient and stable graph cut integer optimization method for both phase unwrap and stereo-matching.

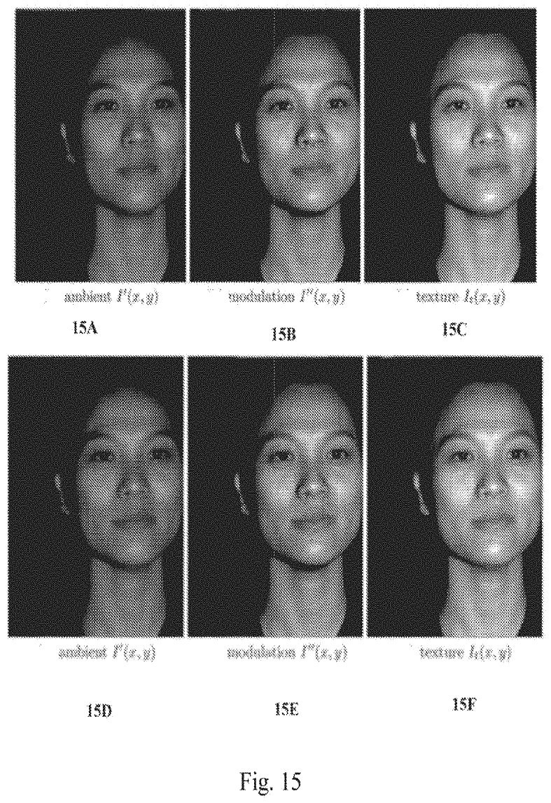

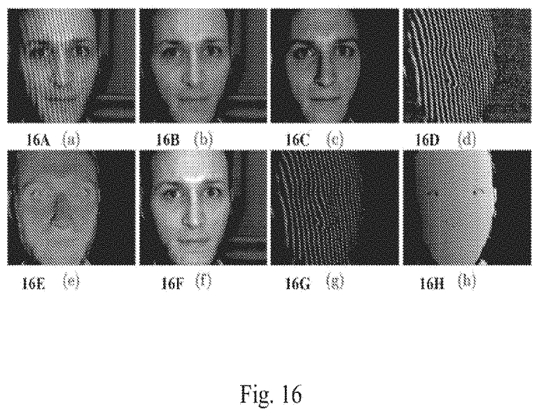

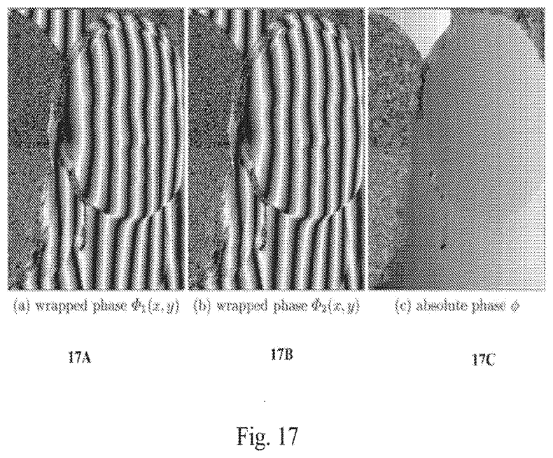

Unwrapping Phase Processes. FIGS. 16A-16H depict various images generated during stages of the phase unwrapping processes. First, fringe images are use solve Eqn. (6) to get average intensity I′, fringe modulation I″ and the phase difference ϕ by Eqn. (8), Eqn. (9) and Eqn. (7). After the above variables are solved, the data modulation γ=I″/I′ and texture Iₜ=I′+I″ can be acquired directly. Once the unwrapped phase is obtained using one or more of phase unwrapping techniques described above, values on each pixel can be one-to-one mapped to real-world coordinates. FIGS. 17A-17C depicts images generated where a.) the wrapped phases Φ₁ with λ₁=45, b.) Φ₂ with 2=48 and c.) the unwrapped (absolute) phase using a double wave-length phase unwrapping algorithm.

Phase to Geometry. On each pixel on the camera image plane (u_{c}, v_{c}), the unwrapped phase is obtained as φ(u_{c}, v_{c}), the corresponding world coordinates (X_{w}, Y_{w}, Z_{w}) may be recovered by the extrinsic and intrinsic parameters of both the camera and the projector. The depth of the pixel may be approximated by a polynomial in Eqn. (34): Z_{w}(u_{c}, v_{c})=a₀(u_{c}, v_{c})+a₁(u_{c}, v_{c})φ(u_{c}, v_{c})+a₂(u_{c}, v_{c})φ²(u,v)+a₃(u_{c}, v_{c})φ³(u_{c}, v_{c})+ . . . , where all the coefficients a₀(u_{c}, v_{c}), a₁ (u_{c}, v_{c}), . . . are estimated by the calibration process.

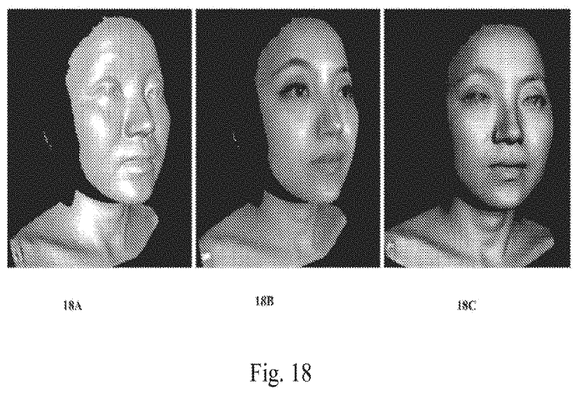

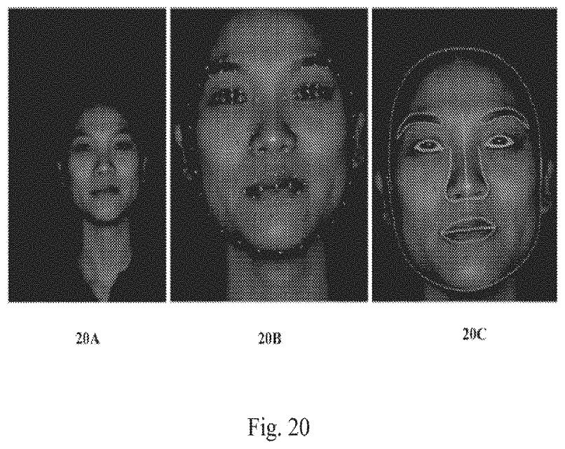

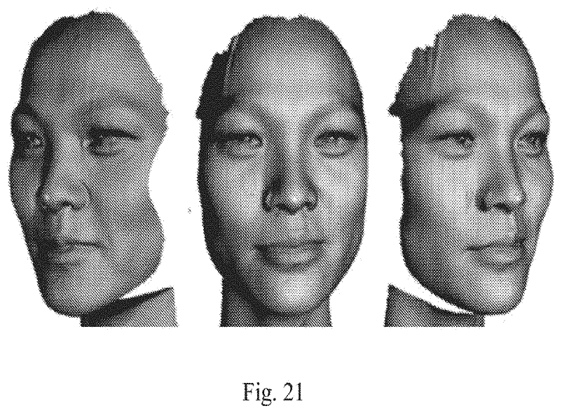

FIG. 18A depicts an example of a facial geometric surface FIG. 18B depicts an example of a geometric surface with gray scale texture mapping, and FIG. 18C depicts an example of a color texture mapping; all which may be generated by exemplary embodiments of the present systems and methods described herein. FIG. 19 depicts an example of a reconstructed facial surface with texture mapping with different view angles, FIG. 20 depicts face detection and facial landmarks extraction on the color texture image using the ensemble of regression trees (ERT) algorithm, and FIG. 21 depicts an example of a geometric surface with color texture.

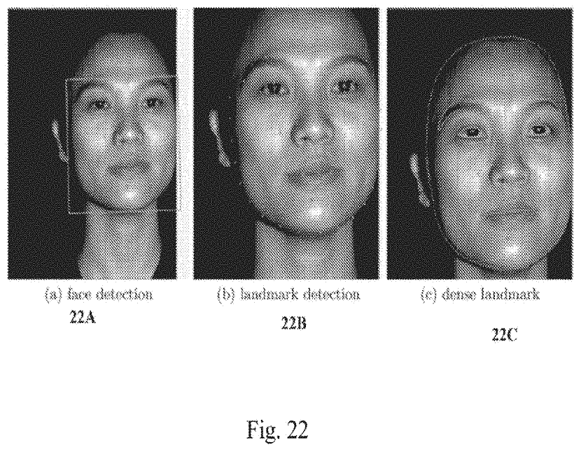

Face Detection and Facial Feature Extraction. The texture image obtained as described in exemplary embodiments may be used to detect a facial region of a person, and then may further be used to find facial landmarks and to perform facial feature extraction using deep learning-based computer vision algorithms, as shown in FIG. 20. And FIG. 22. FIGS. 22A-22C depict an example of the detection of a facial region of a person using SSD structure network, the finding of facial landmarks, and the performance of facial feature extraction using ensemble of regression trees (ERT) algorithm in computer vision, respectively.

A facial feature extraction algorithm may locate the eye, nose, mouth eye brow regions. The image formation model in Eqn. (5) assumes the surface exhibits a Lambertian reflectance property. Human skin is Lambertian, but the surface of eyes is glossy. So the model may not be suitable for eye surfaces. Therefore, the phase information reconstructed for the pixels in the eye regions may be unreliable. The facial skin area may be used to define a quality map and a mask, which may be used in phase unwrapping algorithms, such as the quality-guided path following algorithm and mask cut algorithm, Flynn's minimum discontinuity algorithm.

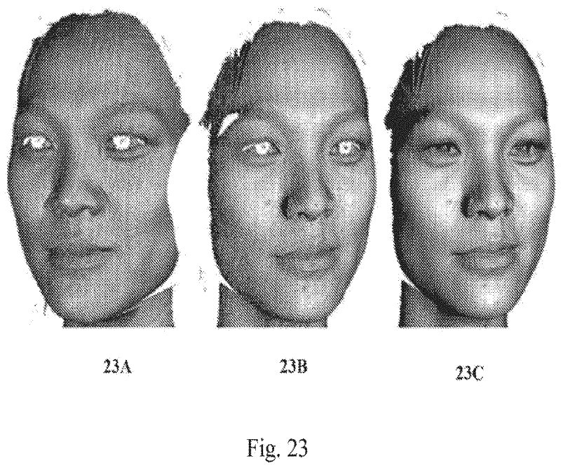

The facial feature extraction algorithm may be used to find the eye regions. Exemplary embodiments of the present systems and methods may compute the phase information for the facial skin surface except for the eye regions. FIG. 23A-23C depict examples of geometric surfaces generated during the reconstruction of the facial skin surface using the phase information and processed by a hole-fill algorithm as described in exemplary embodiments herein. As shown in FIG. 23 the facial skin surface 23A, and 23B is first generated without an eye region. The eye regions may be filled using different algorithms thereafter. For example, the eye regions may be reconstructed by computing a harmonic surface with Dirichlet boundary conditions as shown in 23C. The phase map may also be median filtered to improve the smoothness of the image.

Feedback between low-level vision and high-level vision. Exemplary embodiments of the present systems and methods may use the feedback between low-level vision and the high-level vision. Conventional imaging systems use a bottom-up approach, which processes low-level tasks first, including denoising, edge detection, segmentation, and feature extraction, followed by high-level tasks, including face detection, and pose estimation. Exemplary embodiments may use feedback from the high-level vision to improve the low-level vision and update the high-level tasks. The low-level segmentation, for example, can be corrected and refined by high-level face detection. As another example, the phase unwrapping can be enhanced by extracting the eye and mouth regions, while the stereo-matching can be refined by pose estimation and so on. The high-level vision tasks can be achieved using deep learning methods, such as SSD structure network for face detection and an ensemble of regression trees for facial landmark extraction and the low-level tasks mainly depend on conventional 3D vision algorithms such as markov random fields.

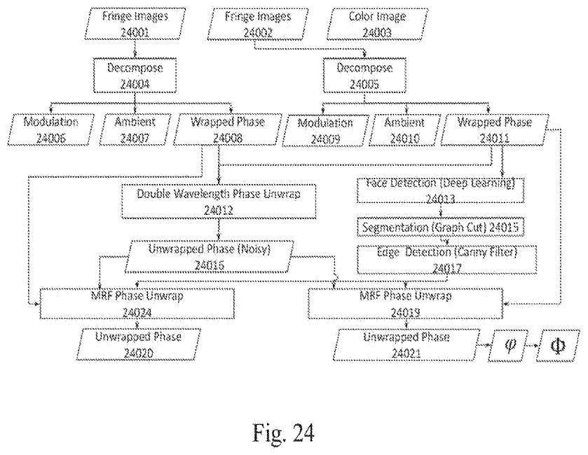

3D Acquisition Process. Reference is now made to FIG. 24 which is a flow chart illustrating an example of a 3D acquisition process of an exemplary embodiment of the present systems and methods and further illustrates the phase map generation of Step 110 in FIG. 1. The projector projects fringe patterns onto a 3D object, the camera captures the image of the object lit by the structured light. Each phase line in the projector fringe image is distorted to a curve on the 3D object, and projected to a curve on the camera image. At 24001 and 24002 the system in exemplary embodiments may capture fringe images from a gray scale camera. The system may also capture a color image 24003 of the object from a color camera. The fringe images 24001 and 24002 may be decomposed using Eqn. (8) or by using a Hilbert transformation algorithm in corresponding blocks 24004 and 24005 by the processor of a computer system as described herein. The processor may process each of the raw fringe images to obtain the modulation components (24006, 24009), the ambient components (24007, 24010), and the wrapped phase components (24008, 24011) of the raw fringe image. To unwrap the phase, embodiments of the system may use a double wavelength phase unwrap algorithm 24012, a quality-guidance path following algorithm (not shown), or another unwrapped phase (noisy) process (24016), or/and a Markov Random Phase Unwrap Algorithm 24020 to compute an absolute phase to generate a phase map for the images so that depth information may be obtained. For example, the wrapped phase components 24008, 24011 of the two fringe images are applied to a double wavelength phase unwrap process in block 24012. This process generates noisy unwrapped phase components 24016.

As further illustrated in FIG. 24, the wrapped phase 24011 may also be combined with other procedures such as deep learning techniques 31013, segmentation, such as using graph cut methodology 24015, and/or edge detection using a canny filter or similar technique 24017. Such processes may make certain applications of the 3D scanning system in the exemplary embodiments more efficient for specific 3D acquisition tasks. Exemplary embodiments advantageously may use from high level tasks (such as face detection, facial landmark extraction, and pose estimation) as feedback to process low-level tasks (such as denoising, edge detection, segmentation, and phase unwrapping). The low-level algorithms, such as segmentation and phase unwrapping can be corrected and refined by high-level face detection. The phase unwrapping can be enhanced by extracting the eye and mouth regions, while the stereo-matching can be refined by pose estimation and so on.

After such processes are applied, the wrapped phase may be unwrapped by a Markov random field (“MRF”) phase unwrap algorithm 24020 described above to compute an absolute phase 24021 to generate a phase map for the images so that depth information may be obtained. Each channel may employ a MRF phase unwrap process, 24024, 24019, which receive the noisy unwrapped phase components from block 24016, the outputs from the high level and low level processing such as block 24013, 24015, 24017, as well as the corresponding wrapped phase components 24008, 24011, to generate the final unwrapped phase components 24020, 24021.

Camera and Project Calibration. Model of Camera and Projector. For camera and projector calibration, exemplary embodiments of the present system and methods may use a nonlinear distortion camera model. One aspect of this process is to model the map from phase to height and its inverse. Because these maps are highly nonlinear, exemplary embodiments of the present systems and methods use higher-order polynomials to approximate the maps for each pixel of the camera. All the approximation coefficients are computed during the calibration procedure and stored in the configuration file. This approach will ensure both accuracy and real-time computation.

The mathematical model for camera and projector may be described using the following pipeline:

$$\begin{matrix}( {X}_{w} , {Y}_{w} , {Z}_{w} ) & {⟶}^{{φ}^{\hat{}} {c}_{1}} ( {X}_{c} , {Y}_{c} , {Z}_{c} ) {⟶}^{{φ}^{\hat{}} {c}_{2}} ( {x}_{c} , {y}_{c} ) {⟶}^{{φ}^{\hat{}} {c}_{3}} ( {x}_{c}^{d} , {y}_{c}^{d} ) {⟶}^{{φ}^{\hat{}} c 4} & ( {u}_{c} , {v}_{c} ) \\ ↓ 𝒾𝒹 & & ↓ ψ \\ ( {X}_{w} , {Y}_{w} , {Z}_{w} ) & & \\ {⟶}^{{φ}^{\hat{}} p 1} & ( {X}_{p} , {Y}_{p} , {Z}_{p} ) {⟶}^{{φ}^{\hat{}} {p}_{2}} ( {x}_{c} , {y}_{c} ) {⟶}^{{φ}^{\hat{}} {p}_{3}} ( {x}_{p}^{d} , {y}_{p}^{d} ) {⟶}^{{φ}^{\hat{}} {p}_{4}} & ( {u}_{p} , {v}_{p} )\end{matrix}$$

The top row shows the image formation process of the camera, the bottom row shows the image formation of the projector.

The map φ₁: (X_{W}, Y_{W}, Z_{W})→(X_{c}, Y_{c}, Z_{c}) transforms from the world coordinates to the camera coordinates, which is a rotation and a translation, as shown in Eqn. (17).

φ₂: (X_{c}, Y_{c}, Z_{c})→(x_{c}, y_{c}) is the pinhole camera projection, maps from camera coordinates to the camera projective coordinates, as shown in Eqn. (18).

φ₃: (x_{c}, y_{c})→(x_{c}^{d}, y_{c}^{d}) is the camera distortion map in Eqn. (21), transforms from camera projective coordinates to the distorted camera projective coordinates, the distortion includes both radial distortion Eqn. (19) and tangential distortion Eqn. (20),

φ₄: (x_{c}^{d}, y_{c}^{d})→(u_{c}, v_{c}.) is the projective transformation in Eqn. (22), which maps from the distorted camera projective coordinates to the camera image coordinates.

The inverse of φ₃ maps from the distorted camera projective coordinates to the camera projective coordinates, φ₃⁻¹: (x_{c}^{d}, y_{c}^{d})→(x_{c}, y_{c}), is Heikkila's formula in Eqn. (23).

Due to the optical path inverse principle, the projector can be treated as the inverse of a camera. If a plane in the world r is fixed, which is called a virtual reference plane, then the mapping for the virtual reference planar coordinates (x_{π}, y_{π}) to the camera image coordinates (u_{c}, v_{c}) is bijective, to projector image coordinates (uₚ, vₚ) is also bijective:

$$ψ : ( {u}_{c} , {v}_{c} ) {⟶}^{{φ}_{c}^{- 1}} ( {x}_{π} , {y}_{π} ) {⟶}^{{φ}_{p}} ( {u}_{p} , {v}_{p} ) \qquad ( 16 )$$

where φ_{c}=φ₄^{c}∘φ₃^{c}∘φ₂^{c}∘φ₁^{c}, φₚ is defined similarly. The composition φₚ∘φ_{c}⁻¹ gives the mapping ψ: (u_{c}, v_{c})→(uₚ, vₚ).

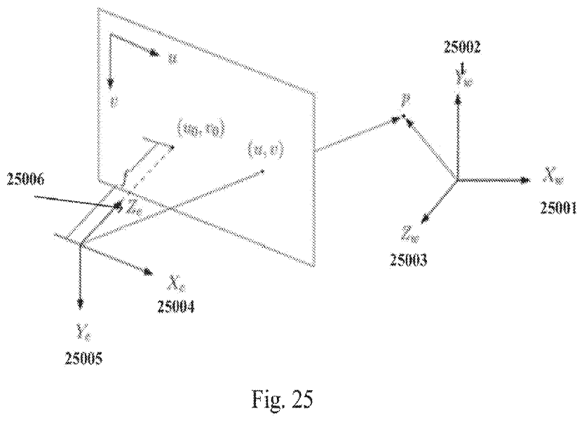

Pinhole Camera Model. FIG. 25 shows the mathematical model of a pinhole camera. (X_{w}, Y_{w}, Z_{w}) (25001, 25002, and 25003, respectively) are the world coordinates, (X_{c}, Y_{c}, Z_{c}) (25004, 25005, and 25006, respectively) the camera coordinates, (u, v) image coordinates. A point p in the world coordinate system is (X_{w}, Y_{w}, Z_{w}), in the camera coordinate system is (X_{c}, Y_{c}, Z_{c}), then

$$[ \begin{matrix}{X}_{c} \\ {Y}_{c} \\ {Z}_{c}\end{matrix} ] = R [ \begin{matrix}{X}_{w} \\ {Y}_{w} \\ {Z}_{w}\end{matrix} ] + T . \qquad ( 17 )$$

where R is the rotation matrix from the world coordinate system to the camera coordinate system, T is the translation vector.

The projection to the camera projective coordinates (without considering distortions) is determined by:

$$\{ \begin{matrix}{x}_{c} = {X}_{c} / {Z}_{c} \\ {y}_{c} = {Y}_{c} / {Z}_{c}\end{matrix} \qquad ( 18 )$$

Distortions Model. In practice, the lens of the camera introduces distortions, the imaging is not ideal pinhole camera model, in calibration the distortions need to be considered. In general, the distortion includes both radial distortion and tangential distortion. (x, y) may be used to represent the projective coordinates on the image plane, such as (x_{c}, y_{c}). The radial distortion (δₓᵣ, δ_{yr}) may be represented as:

$$\{ \begin{matrix}{δ}_{xr} ( x , y ) = x ( {k}_{1} {r}^{2} + {k}_{2} {r}^{4} + {k}_{3} {r}^{6} + … ) , \\ {δ}_{yr} ( x , y ) = y ( {k}_{1} {r}^{2} + {k}_{2} {r}^{4} + {k}_{3} {r}^{6} + … ) ,\end{matrix} \qquad ( 19 )$$

where r²=x²+y², k₁, k₂, k₃, . . . are the radial distortion parameters. The tangential distortion (δₓₜ,δ_{yt}) may be be represented as:

$$\{ \begin{matrix}{δ}_{xt} ( x , y ) = 2 {p}_{1} xy + {p}_{2} ( {r}^{2} + 2 {x}^{2} ) , \\ {δ}_{yt} ( x , y ) = {p}_{1} ( {r}^{2} + 2 {y}^{2} ) + 2 {p}_{2} xy ,\end{matrix} \qquad ( 20 )$$

where p₁, p₂ are tangential distortion parameters.

After considering the camera distortion, the distorted camera projective coordinates (x_{d}, y_{d}) of the point p may be represented as:

$$\{ \begin{matrix}{x}_{d} = x + {δ}_{xr} ( x , y ) + {δ}_{xt} ( x , y ) \\ {y}_{d} = y + {δ}_{yr} ( x , y ) + {δ}_{yt} ( x , y )\end{matrix} \qquad ( 21 )$$

After projective transformation, the camera image coordinates of the point p may be represented as:

$$[ \begin{matrix}u \\ v \\ 1\end{matrix} ] = [ \begin{matrix}{f}_{u} & s & {u}_{0} \\ 0 & {f}_{v} & {v}_{0} \\ 0 & 0 & 1\end{matrix} ] [ \begin{matrix}{x}_{d} \\ {y}_{d} \\ 1\end{matrix} ] = A [ \begin{matrix}{x}_{d} \\ {y}_{d} \\ 1\end{matrix} ] \qquad ( 22 )$$

where fᵤ, fᵥ are the effective focal lengths along u and v directions respectively, s is the slant parameter of the coordinate axis, (u₀, v₀) are the coordinates of principle point, the intersection point between the optical axis of the camera and the image plane.

Camera Calibration. Camera calibration aims at finding significant parameters of the camera, including:
Extrinsic parameters: rotation R, translation T;
Intrinsic parameters: effective focal lengths fᵤ, fᵤ; slant parameters, principle center (u₀, v₀); and
Distortion parameters: radial distortion parameters k₁, k₂, and k₃; and tangential distortion parameters p₁, and p₂.

In practice, intrinsic parameters also include distortion parameters. Generally, k₃ and s are small enough, and usually treated as zero in the equations. The extrinsic and intrinsic parameters may be denoted as:

μ=(R_{c},T_{c},fᵤ,fᵥ,s,u₀,v₀),

and all of the distortion parameters may be denoted as:

Δ=(k₁,k₂,k₃,p₁,p₂)

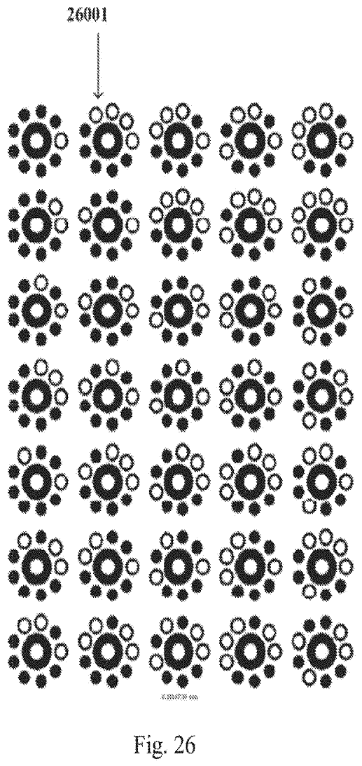

Target Board. FIG. 26 shows a star-planet pattern on the target board for calibration. There are 7×5 star systems, each star is surrounded by 9 planets. Each planet is either a solid circle or a hollow circle. Each hollow circle is denoted as 1 and solid circle as 0. The 9 planets encode a binary string. For example, the top row second column planet system 26001 represents the string 111100000. Two binary strings are equivalent if they differ by a circular permutation. The centers of the stars are detected using ellipse detector. Each binary string is used to differentiate different star systems. As illustrated in FIG. 26, the center of the top left star is the origin of the world coordinates system, the horizontal and vertical directions are along X_{w} and Y_{w} axis, and the direction normal to the target plane is the Z_{w} axis.

During the calibration processes, exemplary embodiments of the present systems and methods fix the position of the target board plane 7C, and treat the local coordinates system of the target plane as the world coordinates system. The plane equation is Z_{w}=0, and the centers of every star center are known, and are denoted as

{(X_{w}¹,Y_{w}¹),(X_{w}²,Y_{w}²), . . . ,(X_{w}ⁿ,Y_{w}ⁿ)},

the image coordinates of each star center are captured during the calibration process, and denoted as:

{(u₁,v₁),(u₂,v₂), . . . ,(uₙ,vₙ)}.

From the mapping of the coordinates, {(X_{w}ⁱ, Y_{w}ⁱ)} to {(uᵢ, vᵢ)}, exemplary embodiments can estimate the extrinsic and intrinsic parameters μ.

The projector can be treated as the inverse of a camera. Exemplary embodiments of the present system and methods may project sinusoidal fringe pattern to the target bards. The {(X_{w}ⁱ, Y_{w}ⁱ)} are the centers of the stars on the target board. The corresponding {(uₚⁱ, vₚⁱ)} can be carried out by the unwrapped phases at {(u_{c}ⁱ, v_{c}ⁱ)}, (φₓⁱ, φ_{y}ⁱ), extracted from fringe images.

Intrinsic and Extrinsic Parameters Estimation. The image formation mapping, also called the forward projection, depends on the extrinsic and the intrinsic parameters,

φ_{uλ}:(X_{w},Y_{w},Z_{w})→(u,v).

The calibration problem is formulated as an optimization problem:

$${min}_{λ , μ} E ( λ , μ ) = {min}_{λ , μ} {{\sum }^{n}}_{i = 1} {‖ φ\_ \{ λ , μ \} ( {X}_{w}^{i} , {Y}_{w}^{i} ) - ( {u}_{i ,} {v}_{i ,} ) ‖}^{2}$$

Exemplary embodiments may use Zhang's algorithm to estimate μ, the extrinsic and intrinsic parameters; then fix μ, optimize E(λ, μ) with respect to λ; third, fix λ and optimize E(λ,μ) with respect to μ. Zhang's algorithm is further described in Z. Zhang, A Flexible New Technique For Camera Calibration, IEEE Transactions on Pattern Analysis and Machine Intelligence, 22(11):1330-1334, 2000 which is incorporated by reference herein. By alternating optimizations, we can reach the optimum by using the following equation:

(λ*,μ*)=argmin_{λ,μ}E(λ,μ).

The optimization can be carried out using gradient descend algorithm:

$$\frac{∇ E}{\partial λ} = {[ \frac{\partial E}{\partial {k}_{1}} , \frac{\partial E}{\partial {k}_{2}} , \frac{\partial E}{\partial {k}_{3}} , \frac{\partial E}{\partial {p}_{1}} , \frac{\partial E}{\partial {p}_{2}} ]}^{T} .$$

The intrinsic and extrinsic parameters of the projector can be estimated using the similar algorithm.

Distorted Calibration Board. In practice, the target boards used for calibration are not ideal planes. There are always small distortions from the ideal situations. Therefore, in the optimization process, exemplary embodiments of the present systems and methods also treat the centers of the star systems as variables. For each center, the ideal world coordinates are (X_{w}ⁱ, Y_{w}ⁱ, Z_{w}ⁱ), where z_{w}ⁱ is zero. Deviations of the coordinates may be denoted as (∈ₓⁱ, ∈_{y}ⁱ, ∈_{z}ⁱ). The real world coordinates for the center may be represented as:

(\hat{X}_{w}ⁱ,Ŷ_{w}ⁱ,\hat{Z}_{w}ⁱ):=(X_{w}ⁱ+εₓⁱ,Y_{w}ⁱ+ε_{y}ⁱ,Z_{w}ⁱ+ε_{z}ⁱ),

The deviations can be represented as:

ε:={(εₓⁱ,ε_{y}ⁱ,ε_{z}ⁱ)}ᵢ₌₁ⁿ.

Then the energy of the system may be represented as:

$$E ( λ , μ , ε ) = {{\sum }^{n}}_{i = 1} {‖ φ\_ \{ λ , μ \} ( {\hat{X}}_{ω}^{i} , {\hat{Y}}_{ω}^{i} , {\hat{Z}}_{ω}^{i} ) - ( {u}_{i} , {v}_{i} ) ‖}^{2} + {( {ε}_{x}^{i} )}^{2} + {( {ε}_{y}^{i} )}^{2} + {( {ε}_{z}^{i} )}^{2} .$$

The calibration is preferably carried out by minimizing the energy based on the following formula:

$${min}_{λ , μ , ε} E ( λ , μ , ε ) ,$$

Treating the centers of the star system as variables in this described manner improves calibration accuracy.

Model of Phase-Height Map. Back Projection: Heikkil's formula. The inverse of the forward projection ω_{λ, μ} is called the back projection. Because the radial distortion Eqn. (19) and the tangential distortion Eqn. (20) are nonlinear, the transformation from (x, y) to (x_{d}, y_{d}) in Eqn. (21) cannot be directly inverted. The use of an iterative method or polynomial approximation may be needed to invert Eqn. (21).

Embodiments may use Heikkila's polynomial approximation to compute the inverse transformation:

$$[ \begin{matrix}x \\ y\end{matrix} ] = \frac{1}{G} [ \begin{matrix}{x}_{d} ( 1 + {a}_{1} {r}_{d}^{2} + {a}_{2} {r}_{d}^{4} ) + 2 {a}_{3} {x}_{d} {y}_{d} + {a}_{4} ( {r}_{d}^{2} + 2 {x}_{d}^{2} ) \\ {y}_{d} ( 1 + {a}_{1} {r}_{d}^{2} + {a}_{2} {r}_{d}^{4} ) + {a}_{3} ( {x}_{d}^{2} + 2 {y}_{d}^{2} ) + 2 {a}_{4} {x}_{d} {y}_{d}\end{matrix} ] , \qquad ( 23 )$$

Where G is defined as:

G=(a₅r_{d}²+a₆x_{d}+a₇y_{d}+a₈)r_{d}²+1, (24)

and r_{d}²=x_{d}²+y_{d}², a₁, a₂, . . . , a₈ are back projection distortion parameters.

Phase Distribution on the Virtual Reference Plane. Exemplary embodiments of the present system and methods may calculate the phase distribution on the virtual reference plane based on the following description. The back projection may be computed based on the following, assuming that the camera parameters λ, μ with respect to the system coordinates system are known:

$$( {u}_{c} , {v}_{c} ) {⟶}^{{φ}_{4}^{- 1}} ( {x}_{c}^{d} , {y}_{c}^{d} ) {⟶}^{{φ}_{3}^{- 1}} ( {x}_{c} , {y}_{c} ) {⟶}^{{φ}_{2}^{- 1}} ( {X}_{c} , {Y}_{c} , {Z}_{c} ) {⟶}^{{φ}_{1}^{- 1}} ( {X}_{w} , {Y}_{w} , {Z}_{w} )$$

For a point (u_{c}, v_{c}) on the camera image plane, the coordinates (x, y) may be obtained by using Eqn. (22) and Eqn. (23), and then the following formula may be obtained using Eqn. (17) with the coordinates:

$$[ \begin{matrix}{xZ}_{c} \\ {yZ}_{c} \\ {Z}_{c}\end{matrix} ] = {R}_{c} [ \begin{matrix}{X}_{w} \\ {Y}_{w} \\ {Z}_{w}\end{matrix} ] + {T}_{c} , \qquad ( 25 )$$

if the height Z_{w} is fixed, from above equation, the following formula may be derived:

$$[ \begin{matrix}{Z}_{c} \\ {X}_{w} \\ {Y}_{w}\end{matrix} ] = {B}^{- 1} [ \begin{matrix}{T}_{c 1} + {R}_{c 13} {Z}_{w} \\ {T}_{c 2} + {R}_{c 23} {Z}_{w} \\ {T}_{c 3} + {R}_{c 33} {Z}_{w}\end{matrix} ] , \qquad ( 26 )$$

Where B is denoted as:

$$B = [ \begin{matrix}x - {R}_{c 11} - {R}_{c 12} \\ y - {R}_{c 21} - {R}_{c 22} \\ 1 - {R}_{c 31} - {R}_{c 32}\end{matrix} ] . \qquad ( 27 )$$

The aforementioned equations enable exemplary embodiments of the system to generate a map from (u_{c}, v_{c}) to (X_{w}, Y_{w}) for a virtual reference plane with the fixed height Z_{w}.

Similarly, after all of the intrinsic, extrinsic and distortion parameters of the projector are ascertained via the described calibration process, then by formulas set forth in Eqn. (17), Eqn. (18), Eqn. (19), Eqn. (20), Eqn. (21) and Eqn. (22), the present methods may map (X_{w}, Y_{w}) on the virtual reference plane with the fixed Z_{w} to the projector image coordinates (uₚ, vₚ). The composition gives the map from (u_{c}, v_{c}) to (uₚ, vₚ).

$$( {u}_{c} , {v}_{c} ) {⟶}^{{φ}_{c}^{- 1}} ( {X}_{w} , {Y}_{w} , {Z}_{w} ) {⟶}^{{φ}_{p}} ( {u}_{p} , {v}_{p} ) .$$

In the calibration process, the projector image coordinates (uₚ, vₚ) may be represented as the fringe phase, this gives the phase distribution on the corresponding virtual reference plane.

If we fix a virtual reference plane Z_{w}=z, the mapping φₚ∘φ_{c}⁻¹ gives the phase at each (u_{c}, v_{c}), we denote this mapping as

f_{z}(u_{c},v_{c})=φ(u_{c},v_{c})∈[−π,π]. (28)

Phase-Height Mapping Modeling. Exemplary embodiments may include a Phase Measurement Profilometry (PMP) system, which allows, in accordance with the optimal path invertible principle, the treatment of the projector as a camera. The following relationships may be obtained assuming that there are no distortions:

$$[ \begin{matrix}{X}_{c} \\ {Y}_{c} \\ {Z}_{c}\end{matrix} ] = {R}_{c} [ \begin{matrix}{X}_{w} \\ {Y}_{w} \\ {Z}_{w}\end{matrix} ] + {T}_{c} , [ \begin{matrix}{X}_{p} \\ {Y}_{p} \\ {Z}_{p}\end{matrix} ] = {R}_{p} [ \begin{matrix}{X}_{w} \\ {Y}_{w} \\ {Z}_{w}\end{matrix} ] + {T}_{p} ,$$

This allowance the following relationships to be denoted:

$$\{ \begin{matrix}{R}_{c 11} {X}_{w} + {R}_{c 12} {Y}_{w} + {R}_{c 13} {Z}_{w} + {T}_{c 1} = {x}_{c} ( {R}_{c 31} {X}_{w} + {R}_{c 32} {Y}_{w} + {R}_{c 33} {Z}_{w} + {T}_{c 3} ) \\ {R}_{c 21} {X}_{w} + {R}_{c 22} {Y}_{w} + {R}_{c 23} {Z}_{w} + {T}_{c 2} = {y}_{c} ( {R}_{c 31} {X}_{w} + {R}_{c 32} {Y}_{w} + {R}_{c 33} {Z}_{w} + {T}_{c 3} ) \\ {R}_{p 11} {X}_{w} + {R}_{p 12} {Y}_{w} + {R}_{p 13} {Z}_{w} + {T}_{p 1} = {x}_{p} ( {R}_{p 31} {X}_{w} + {R}_{p 32} {Y}_{w} + {R}_{p 33} {Z}_{w} + {T}_{p 3} ) \\ {R}_{p 21} {X}_{w} + {R}_{p 22} {Y}_{w} + {R}_{p 23} {Z}_{w} + {T}_{p 2} = {y}_{p} ( {R}_{p 31} {X}_{w} + {R}_{p 32} {Y}_{w} + {R}_{p 33} {Z}_{w} + {T}_{p 3} )\end{matrix}$$

In the above relationship, x_{c}=X_{c}/Z_{c}, y_{c}=Y_{c}/Z_{c}, xₚ=Xₚ/Zₚ, yₚ=Yₚ/Zₚ. The first 3 relationships in the above may form the following linear equation group:

$$\{ \begin{matrix}( {R}_{c 11} - {R}_{c 31} {x}_{c} ) {X}_{w} + ( {R}_{c 12} - {R}_{c 32} {x}_{c} ) {Y}_{w} + ( {R}_{c 13} - {R}_{c 33} {x}_{c} ) {Z}_{w} = {T}_{c 3} {x}_{c} - {T}_{c 1} \\ ( {R}_{c 21} - {R}_{c 31} {y}_{c} ) {X}_{w} + ( {R}_{c 12} - {R}_{c 32} {y}_{c} ) {Y}_{w} + ( {R}_{c 13} - {R}_{c 33} {y}_{c} ) {Z}_{w} = {T}_{c 3} {y}_{c} - {T}_{c 2} \\ ( {R}_{p 11} - {R}_{p 31} {x}_{p} ) {X}_{w} + ( {R}_{p 12} - {R}_{p 32} {x}_{p} ) {Y}_{w} + ( {R}_{p 13} - {R}_{p 33} {x}_{c} ) {Z}_{w} = {T}_{p 3} {x}_{p} - {T}_{p 1}\end{matrix}$$

The linear equation group may be further simplified as

$$\{ \begin{matrix}{a}_{1} {X}_{w} + {b}_{1} {Y}_{w} + {c}_{1} {Z}_{w} = {d}_{1} \\ {a}_{2} {X}_{w} + {b}_{2} {Y}_{w} + {c}_{2} {Z}_{w} = {d}_{2} \\ {a}_{3} {X}_{w} + {b}_{3} {Y}_{w} + {c}_{3} {Z}_{w} = {d}_{3}\end{matrix}$$

The following equation may be derived from the simplification:

$${Z}_{w} = \frac{( {a}_{2} {d}_{1} - {a}_{1} {d}_{2} ) ( {a}_{3} {b}_{2} - {a}_{2} {b}_{3} ) - ( {a}_{2} {b}_{1} - {a}_{1} {b}_{2} ) ( {a}_{3} {d}_{2} - {a}_{2} {d}_{3} )}{( {a}_{2} {c}_{1} - {a}_{1} {c}_{2} ) ( {a}_{3} {b}_{2} - {a}_{2} {b}_{3} ) - ( {a}_{2} {b}_{1} - {a}_{1} {b}_{2} ) ( {a}_{3} {c}_{1} - {a}_{2} {c}_{3} )} = \frac{{A}_{1} ( {a}_{3} {b}_{2} - {a}_{2} {b}_{3} ) - B ( {a}_{3} {d}_{2} - {a}_{2} {d}_{3} )}{{A}_{2} ( {a}_{3} {b}_{2} - {a}_{2} {b}_{3} ) - B ( {a}_{3} {c}_{1} - {a}_{2} {c}_{3} )}$$

This equation further may lead to the following equation:

$${Z}_{w} = \frac{\begin{matrix}{A}_{1} ( {b}_{2} {R}_{p 11} - {a}_{2} {R}_{p 12} ) - B ( {d}_{2} {R}_{p 11} + {a}_{2} {T}_{p 1} ) + \\ [ {A}_{1} ( {a}_{2} {R}_{p 32} - {b}_{2} {R}_{p 31} ) + B ( {d}_{2} {R}_{p 31} + {a}_{2} {T}_{p 3} ) ] {x}_{p}\end{matrix}}{\begin{matrix}{A}_{1} ( {b}_{2} {R}_{p 11} - {a}_{2} {R}_{p 12} ) - B ( {c}_{1} {R}_{p 11} - {a}_{2} {R}_{p 13} ) + \\ [ {A}_{1} ( {a}_{2} {R}_{p 32} - {b}_{2} {R}_{p 31} ) + B ( {c}_{1} {R}_{p 31} + {a}_{2} {R}_{p 33} ) ] {x}_{p}\end{matrix}} = \frac{{C}_{1} ( {x}_{c} , {y}_{c} ) + {C}_{2} ( {x}_{c} , {y}_{c} ) {x}_{p}}{{C}_{3} ( {x}_{c} , {y}_{c} ) + {C}_{4} ( {x}_{c} , {y}_{c} ) {x}_{p}} \qquad ( 29 )$$

Eqn. 28 enables exemplary embodiments of the system to generate a phase-height mapping without distortion. If C₃(x_{c},y_{c})>>C₄(x_{c},y_{c})xₚ (generally most PMP systems will satisfy this condition), the following equation may be obtained:

Z_{w}=k₀(x_{c},y_{c})+k₁(x_{c},y_{c})xₚ+k₂(x_{c},y_{c})xₚ²+k₃(x_{c},y_{c})xₚ³+ . . . (30)

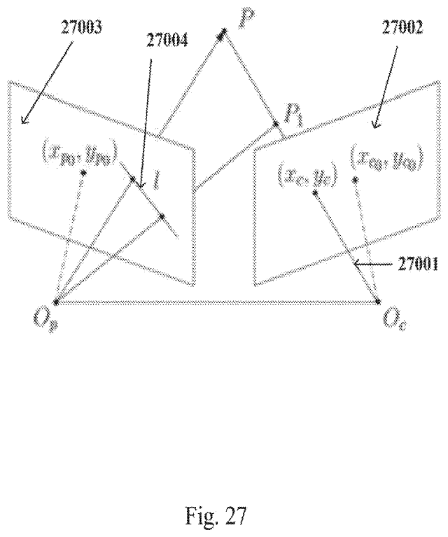

As shown in FIG. 27, which illustrates the imaging relationship between the camera and projector in exemplary embodiments of the present system and methods, the straight line O_{c}P, 27001, is projected on the projector image plane as a line l, 27004, therefore every point (x_{c},y_{c}) on the camera image plane 27002 corresponds to a line on the projector image plane 27003. If there are distortions, the projection of the line is a complex curve. Such distortions may be complicated to account for, and may be approximated using the following polynomial equations:

xₚ=l₀(x_{c},y_{c})+l₁(x_{c},y_{c})x_{pd}+l₂(x_{c},y_{c})x_{pd}²+l₃(x_{c},y_{c})x_{pd}³+ . . . (31)

Eqn. (31) may be plugged into Eqn. (30), to acquire the following polynomial expression:

Z_{w}(x_{c},y_{c})=k₀′(x_{c},y_{c})+k₁′(x_{c},y_{c})x_{pd}+k₂′(x_{c},y_{c})x_{pd}²+k₃′(x_{c},y_{c})x_{pd}³+ . . . (32)

In the PMP system described in exemplary embodiments, the phase of the fringe is linearly distributed on the projector image plane, therefore the phase φ may be used to represent the projector image coordinates uₚ, x_{pd} as a linear function of uₚ. This consideration enables Eqn. (32) to be computed as:

Z_{w}(x_{c},y_{c})=k₀″(x_{c},y_{c})+k₁″(x_{c},y_{c})φ(x_{c},y_{c})+k₂″(x_{c},y_{c})φ(x_{c},y_{c})²+k₃″(x_{c},y_{c})φ(x_{c},y_{c})³+ . . . (33)

As previously described herein, it is known that the following mapping relationship is nonlinear:

$$( {x}_{c} , {y}_{c} ) {⟶}^{φ3} ( {x}_{d} , {y}_{d} ) {⟶}^{φ4} ( {u}_{c} , {v}_{c} ) ,$$

The inverse relationship φ₃⁻¹∘φ₄⁻¹:(u_{c}, v_{c})→(x_{c}, v_{c}) is also non-linear, If φ₃⁻¹ is approximated by Heikilli's formula, denoted as (x_{c},y_{c})=f(u_{c},v_{c}), the above equation becomes:

$${Z}_{w} o f ( {u}_{c} , {v}_{c} ) = {{\sum }^{∞}}_{i = 0} {k}_{i}^{″} o f ( {u}_{c} , {v}_{c} ) φ o f {( {u}_{c} , {v}_{c} )}^{i} .$$

In this equation, the coefficients kᵢ∘f(u_{c}, v_{c}) may be denoted as aᵢ(u_{c},v_{c}), the phase function φ∘f(u_{c},v_{c}) may be denoted as φ(u_{c},v_{c}), and the depth function Z_{w}∘f(u_{c}, v_{c}) may be denoted as Z_{w}(u_{c},v_{c}). Using these denotations, the present methods may generate a final phase-height mapping formula based on the following:

Z_{w}(u_{c},v_{c})=a₀(u_{c},v_{c})+a₁(u_{c},v_{c})φ(u_{c},v_{c})+a₂(u_{c},v_{c})φ²(u,v)+a₃(u_{c},v_{c})φ³(u_{c},v_{c})+ . . . (34)

Eqn. (34) enables the use of polynomial approximation for phase-height mapping.

Given the extrinsic, intrinsic parameters (including the distortion parameters) of both the camera and the projector, the present methods may compute the phase distribution on the virtual reference plane, represented in Eqn. (28) as f_{z}(u_{c},v_{c}). A set of depths z₁, z₂, . . . , zₙ, may be chosen, and the phase at each pixel on the camera plane may be computed as φ_{z}_{ₖ}(u_{c}, v_{c})=f_{z}_{ₖ}(u_{c}, vₐ). Next the coefficients in Eqn. (34) a₀(u_{c}, vₐ), a₁ (u_{c}, v_{c}), . . . , aₙ(uᵥ, v_{c}), may be computed by the following optimization equation:

$${min}_{{a}_{i} ( {u}_{c} , {v}_{c} )} {\sum }_{k} {‖ {z}_{k} - {\sum }_{i} {a}_{i} ( {u}_{c} , {v}_{c} ) {φ}_{{z}_{k}}^{i} ( {u}_{c} , {v}_{c} ) ‖}^{2} . \qquad ( 35 )$$

Phase-Height Map Calibration. Assuming the intrinsic parameters of the camera are constant, exemplary embodiments may perform phase-height map calibration using the following procedure:
Placing the planar target at different positions in the measuring volume, denoted as in, π₁, π₂, . . . , πₖ. At each position, estimating the transformation matrix from the plane to the camera image plane; the transformation matrices being denoted as (R₁,T₁), (R₂,T₂), . . . , (Rₖ,Tₖ).
For each pair (Rᵢ, Tᵢ) and (Rⱼ, Tⱼ), constructing a linear equation group for intrinsic and extrinsic parameters of the camera, and solving for the intrinsic and and extrinsic parameters μ.
Using optimization methods to compute the distortion parameters λ, and the optimized intrinsic and extrinsic parameters.
Fixing the different depth z's, computing the phase distribution on the virtual reference plane, f_{z}(u_{c},v_{c})'s by using, for example, Eqn. (28).
Approximating the phase-height map by a polynomial of the unwrapped phase at each pixel (u_{c}, v_{c}), using for example, Eqn. (34), the coefficients of which may be estimated using optimization methods, such as the set forth in Eqn. (35).

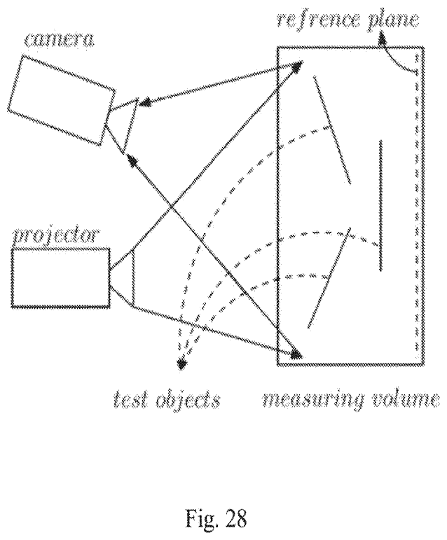

A diagram of an exemplary system used for phase-height map calibration is shown in FIG. 28.

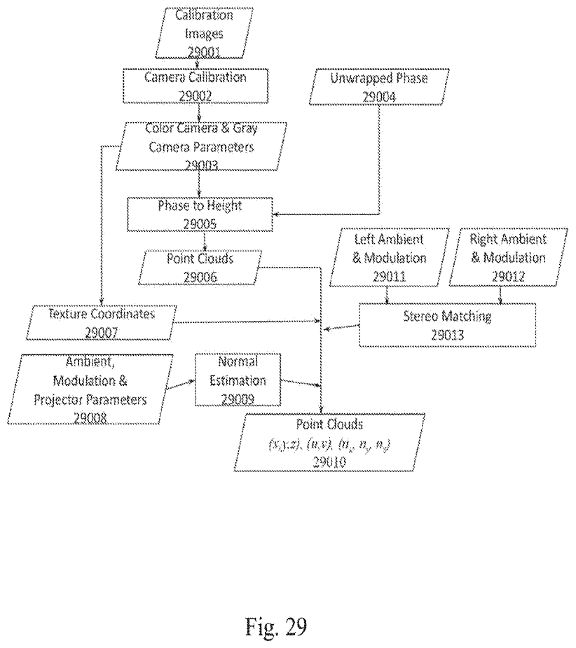

Camera Calibration Process. Reference is now made to FIG. 29 which depicts a flow chart of a camera calibration and point cloud generation process of an exemplary embodiment and further illustrates an example of the operations in block 120 in FIG. 1. At 29001 calibration fringe images may be captured from a camera in the system, using for example, a target board as described herein in FIG. 26. At 29002 a camera calibration process may commence to calibrate various parameters of the camera including intrinsic and extrinsic parameters. Both the parameters of the cameras, e.g. the gray camera, the color camera and the projector may be calibrated at 29002 using optimization equations (such as Zhang's algorithm, and the gradient descend algorithm) with the various raw images obtained from calibration images of, for example, the target board. Note, the cameras can be a single camera or multiple cameras arranged for stereoscopic acquisition. After obtaining the unwrapped phase from the raw images at 29004, a back projection calibration technique using Heikkila's formula can generate a phase to height mapping (29005). From the phase to height mapping, the system may generate point clouds at 29006 based on the fringe calibration images that includes depth information. At the same time, the parameters obtained in 29003 may be used to obtain texture coordinates at 29007. Meanwhile, based on using two cameras, the system may generate left ambient and modulation information at 29011, and right ambient and modulation information at 29012 based on images obtained from the cameras with two different views. A stereo matching algorithm or the like, at 29013 may use the information from 29011 and 29012 to calculate depth information based on the stereoscopic image capture. Based on the ambient, modulation, and projector parameters are inputted at 29008, the surface normal information can be estimated at 29009. Based on the estimated surface normal information 29009, the texture coordinates of the fringe calibration images 29007, the point clouds generated from the fringe calibration images 29006, and the stereo matching information 29013, the system may generate very accurate point clouds, representing a depth image of the object captured by the camera images, that account for all of the inputs described in this figure.

Computational Conformal Geometry Methods. The software used in exemplary embodiments of the present systems and methods is based on computational conformal geometry methods. Additional background information on computational conformal geometry methods is described in X. Gu, R. Guo, F. Luo, J. Sun and T. Wu, A discrete uniformization theorem for polyhedral surface II, Journal of Differential Geometry, 109(3):431-466, 2018 and X. Gu, F. Luo and J. Sun and T. Wu, A discrete uniformization theorem for polyhedral surfaces, Journal of Differential Geometry, 109(2):223-256, 2018, which are both incorporated herein by reference. The conformal geometric method deforms a 3D surface onto a planar domain by preserving local shapes, converting 3D geometric tasks to the corresponding 2D image tasks. To match and register two three-dimensional surfaces, exemplary embodiments may map the surfaces to the planar disks using the Riemann mapping algorithm in conformal geometry, then directly compare their planar images. That is much easier and faster than conventional methods. The conformal geometric method described herein may handle surfaces in the real world with complicated topologies and geometries and map them onto one of three canonical shapes, e.g. asphere, Euclidean plane, or hyperbolic plane. In turn, the quasi-conformal geometric method may be applied to map planar images with various types of constraints and objectives.

For example, the conformal flattening of a 3D shape to the plane can be found using the Ricci flow algorithm, which deforms the Riemannian metric proportional to the current curvature. In this way, the curvature evolves according to a diffusion-reaction process and becomes constant eventually. The mapping with the least elastic distortion energy is modeled as harmonic maps, which can be achieved using the nonlinear heat flow method. The mapping with the least angle distortion is formulated as the Teichmuller map, which can be carried out by searching special Beltrami coefficients in the space of holomorphic differentials. Additional background on this topic is described in X. Yu, N. Lei, Y. Wang, X. Gu, Intrinsic 3D Dynamic Surface Tracking based on Dynamic Ricci Flow and Teichmuller Map, International Conference on Computer Vision 2017, which is incorporated herein by reference. The mapping that preserves area elements can be calculated using the optimal transportation map. Additional background on the usage of optimal transportation maps is described in X. Gu, F. Luo, J. Sun and S-T Yau, Variational Principles for Minkowski Type Problems, Discrete Optimal Transport, and Discrete Monge-Ampere Equations, 20(2):383-398, Asian Journal of Mathematics (AJM), 2016, which is incorporated herein by reference. The conformal flattening and surface registration algorithm may be applied for colon cancer screening. In addition, the present systems and methods may implement deep learning algorithms for image analysis, image surface segmentation, and facial detection applications.

Software functionalities enabled by embodiments of the present systems and methods with respect to skin mapping include:
Surface Registration and Image Registration. The captured sequence of 3D surfaces with texture will be registered precisely so that each anatomical point on the skin will be tracked frame by frame in the sequence. This enables the compassion of sequential images and sequential surfaces.
Geometric, Textural Analysis. This algorithm computes the principal curvature direction field on the skin surface, which traces the wrinkle curves on the surface; the method computes the surface's curvature, the umbilical points, which indicate the roughness of the surface. The algorithm also finds the extremal points of curvatures and color, and these are the feature points on the skin. This method can locate the abnormalities of the skin.
Temporal Change Detection. This tool will quantify the changes in skin color, texture, roughness, local shape, and other applicable measurements.

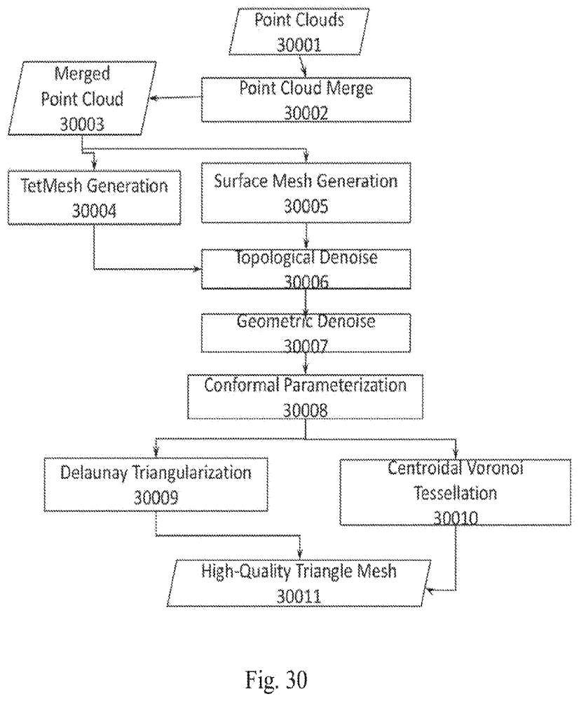

Surface Reconstruction Process. Reference is now made to FIG. 30, which depicts a flow chart showing an exemplary surface reconstruction process in an exemplary embodiment of the present system and methods and further illustrates the operations in block 125 in FIG. 1. At 30001 the system may generate point clouds 30001, by for example, the process outlined in FIG. 29. The system may then perform a process to merge a plurality of point clouds at 30002, to generate a merged point cloud at 30003. From the merged point cloud, the system may perform TetMesh Generation 30004, which is a known process to create a mesh on an arbitrary three-dimensional volume with tetrahedral elements, and surface mesh generation 30005. After performing Surface Mesh Generation, the System may perform topological Denoise at 30006, which remove spurious handles by computing the fundamental group generators of the surface, namely the handle loops and the tunnel loops. The output from the TetMesh Generation at 30004, may be input into the Topical Denois 30006 process for the computational of handle and tunnel loops using the persistent homology method. After, the system may perform Geometric Denoise 30007 on the product of the Topological Denoise process 30006. Next, conformal parametrization 30008 may be performed, and then either Delaunay Triangularization 30009 or Centroidal Voronoi Tessellation 30010 may be performed. Finally, a High Quality Triangle Mesh may be generated at 30011.

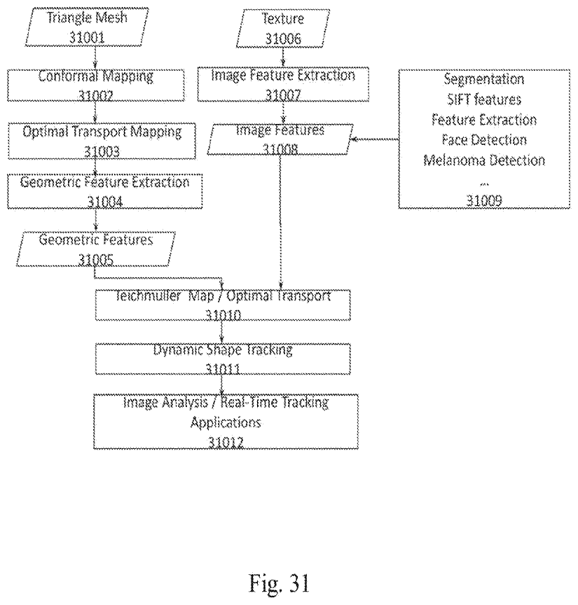

Shape Analysis Process. Reference is now made to FIG. 31, which depicts a flow chart showing an exemplary shape analysis process in an exemplary embodiment of the present system and methods and further illustrates block 130 in FIG. 1. At 31001 a Triangle mesh may be inputted, which may be generated by, for example, the process outlined in FIG. 30. Next Conformal Mapping 31002 may be performed on the Triangle Mesh. A Conformal Mapping algorithm may be applied to conformally map a surface (from the triangle mesh) onto a canonical planar domain, such as mapping a human facial surface onto the unit disk or annulus. In this step, the area distortion factor may be treated as a probability density. The conformal flattening of a 3D shape to the plane can be found using the Ricci flow algorithm which deforms the Riemannian metric proportional to the current curvature. Then Optimal Transport Mapping may be performed 31003. Since conformal mapping introduces area distortion while preserving angles and optimal transport mapping introduces angular distortion while preserving area, the two processes are complementary and combining these processes can provide for more accurate feature extraction. The optimal transport map between the area distortion factor and the Lebesgue measure is computed. The cost of the optimal transportation map gives an important metric among shapes, which can be used for shape classification and analysis as well.

Following this step, the system performs Geometric Feature Extraction 31004, which enables the extraction of Geometric Features 31005. Meanwhile, the system may receive a Texture image 31006, and perform Image Feature Extraction 31007 to obtain Image Features 31008. The Image Features 31008 may be refined and/or otherwise aided by a variety of other techniques, such as Segmentation, SIFT features, Landmark Extraction, Face Detection and Melanoma Detection at 31009. The system may then use Teichmuller Map/Optimal Transport based processes 31010 on both of the Geometric Features 31005 from the Triangle Mesh 31001 and the Image Features 31008 from the Texture image 31006. Next, the system will perform Dynamic Shape Tracking 31011. Finally at 31012 the system may perform Image Analysis and/or use the processed information in Real-Time Tracking Applications.

Applications. The novel system described in the embodiments of the invention may serve as a platform technology that can unlock transformative innovations in a broad spectrum of application areas, including healthcare (e.g., dermatology, orthodontics, plastic surgery, and radiotherapy); cosmetics and skincare; movies and games (e.g., virtual reality and augmented reality); engineering and manufacturing; and security and law enforcement.

Medical Fields. Early detection of melanoma saves lives and improves treatment outcomes by reducing cancer risk to other parts of the body. Early detection and treatment of non-melanoma skin cancers can minimize disfiguring, enhancing the quality of life and productivity for many patients. The automated sequential image analysis software described in the exemplary embodiments of the invention may provide a powerful tool for dermatologists to make informed clinical decisions. As a result, the number of unnecessary biopsies currently being performed due to the inefficiencies and ineffectiveness of existing skin examination methods (i.e., 2D imaging or visual exams under the naked eye) may be significantly reduced. By optimizing the skin evaluation process, saving the doctor's time, lowering the overall cost of care, and facilitating teledermatology services, the technology described in the exemplary embodiments of the invention will make skin cancer screening and early detection more affordable for all patients.

The real-time monitoring solution using the high-performance 3D imaging system described in exemplary embodiments can also be applied to determine accurate patient position monitoring during radiotherapy, ensuring patient safety and effective treatment. By eliminating the need for using X-rays (i.e., on-board kV and CBCT imaging) to track the patient's position, the present technology minimizes radiation exposure, thus improving the health and welfare of patients undergoing cancer treatment. It also eliminates the burden and stress on the therapists who frequently watch the patients for body movements on video monitors without our technology.

The present 3D image analysis software offers an automated position tracking solution with high accuracy and efficiency, resulting in productivity improvement for a patient's cancer care team. For example, in the case of melanoma detection, the face of a patient may be scanned at different times during a year using the system described in the exemplary embodiments, and compared by computational algorithms. The skin may be screened at millimeter resolution to locate abnormalities. Dermatologists may further examine suspicious areas of their patients to make informed medical decision. Comparing to conventional diagnosis process, the procedure enabled by exemplary embodiments of the invention will greatly reduce the time, cost and improve the accuracy.

The system described by exemplary embodiments of the invention can also be applied for dentists comparing deformations of soft tissue induced by Orthodontic procedures and can provide doctors with actionable information for devising customized treatment plans. It can efficiently and precisely monitor the surgeries' effects and make timely and appropriate adjustments to the treatments. Patients will receive a more optimal result from the procedures while minimizing the risk of enduring deformations or other significant side effects. Clinicians benefit from enhanced productivity and job satisfaction from providing high-quality care to their patients

Conventional X-ray imaging can only capture the shape of teeth and bones, but the deformation of soft tissue, like human facial skin, cannot be measured. The system described by exemplary embodiments of the invention can capture the facial shape before and after the orthodontic procedure, and the software can register the surfaces and compare them accurately. Dentists will be able to adjust their operations according to the measurement of the deformations.

The system described by exemplary embodiments of the invention can also be used for plastic surgery applications. It can help doctors evaluate the results of their operations, and make informed surgery plans by enabling the precise recording of 3D shapes of their patients' faces, in order to compare them. Furthermore, the system described by exemplary embodiments of the invention enables the capture of dynamic facial expressions, which will be helpful in the detection and detail of particular facial muscle movement. Such a feature may be used to, for example, evaluate the effects, and aid in the administration of Botox injections.

Games and Movies. The dynamic human facial geometries and textures obtained via the exemplary embodiments of the invention can be applied in the computer game industry and movie industry. Facial expression capture is one of the most challenging tasks in animation. The dynamic geometric data captured by the system can help overcome this challenge.

One of the bottle necks for wide scale Virtual Reality and Augmented Reality implementation is content generation. Today, most animation are generated manually by animators. The invention described herein enables the capture of dynamic VR content more directly than conventional methods.

Security. Integrating the technology described in the exemplary embodiments of the invention into facial recognition applications has great potential in offering a much-needed solution to security. Compared to ID photos in 2D format, 3D facial recognition and advanced real-time dynamic 3D facial recognition using the technology described herein will provide much higher accuracy and reliability. The invention described herein may help facial data acquisition, and can be used for homeland security purposes for public transportation systems, such as airport, train stations, subways and ferry. It can also be used for driver license, social security, passport and banking systems.

Although several embodiments have been disclosed, it should be recognized that these embodiments are not exclusive to each other.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including one or multiple Graphics Processing Units (GPU), a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, Python, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable. The programs may also use special libraries, such as OpenGL, CUDA, Qt, OpenCV, TensorFlow, Pytorch, for example.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A computer implemented system for three dimensional scanning comprising:
a projector configured to project structured light onto a three-dimensional object;
a camera configured to capture fringe images of the object;
a processor configured to process the fringe images to extract a phase map and a texture image, to calculate depth information from the phase map, and to perform 3D surface reconstruction based on the depth information and texture image, wherein the processor generates the phase map based on consideration of an intensity bias component of the fringe images, a modulation component of the fringe images, and an unwrapped phase of the fringe images.

2. The system of claim 1, wherein the structured light comprises a plurality of phase lines, and each phase line is distorted to a curve on the three dimensional object.

3. The system of claim 1, wherein the image is captured by a first camera for capturing the fringe images of the three-dimensional object, and a second camera for capturing a color texture image of the object.

4. The system of claim 3, wherein exposure cycles of both the first and second cameras are synchronized and wherein the first camera is triggered to capture an image on each off cycle, and the second camera is triggered to capture an image every three off cycles.

5-10. (canceled)

11. The system of claim 1, wherein the processor determines the wrapped phase using a quality-guidance path following algorithm by repeating the following steps:
selecting a first pixel;
determining the wrapped phase, Φ(x, y), of the first pixel;
placing pixels neighboring the first pixel into a priority queue;
selecting a second pixel from the priority queue with the highest quality.

12. (canceled)

13. (canceled)

14. (canceled)

15. The system of claim 1, wherein a quality map and a mask of a facial skin area is generated by the texture image, and the quality map and mask is inputted into a phase unwrapping algorithm by the processor to determine an unwrapped phase.

16. The system of claim 1, wherein the processor transforms world coordinates of a point to camera coordinates, transforms the camera coordinates to camera projective coordinates, and transforms the camera projective coordinates to distorted camera projective coordinates

17-25. (canceled)

26. The system of claim 1, wherein at least one point cloud is generated based on the depth information by the processor and the point cloud is processed by the processor to form a triangle mesh; wherein the processor performs conformal geometry methods for image and shape analysis and real-time tracking applications.

27. The system of claim 26, wherein the processor is further configured to use ambient, modulation and projector parameters to estimate surface normal information in the process of generating at least one point cloud.

28. (canceled)

29. (canceled)

30. The system of claim 1, wherein an image is captured from two different viewing angles to obtain stereoscopic depth information; and wherein the processor is configured to use the stereoscopic depth information as an input into the generation of at least one point cloud.

31. (canceled)

32. The system of claim 1, wherein first fringe images are captured at a first time and used to perform a first 3D surface reconstruction by the processor, second fringe images are captured at a second time and used to perform a second 3D reconstruction by the processor, and the first and second 3D reconstructions are registered for comparison.

33-36. (canceled)

37. The system of claim 32, wherein textural features and the geometric features are extracted from the first and second fringe images.

38. (canceled)

39. (canceled)

40. The system of claim 1, wherein the processor is further configured to model a phase-height map as a polynomial function at each pixel the camera, wherein the processor is further configured to estimate coefficients of the polynomial in a camera-projector calibration process using an optimization algorithm.

41. (canceled)

42. A computer implemented method for three dimensional scanning comprising:
projecting structured light onto a three-dimensional object by a projector;
capturing fringe images of the object by a camera;
processing the fringe images to extract a phase map and a texture image by a processor, wherein the processor generates the phase map based on consideration of an intensity bias component of the fringe images, a modulation component of the fringe images, and an unwrapped phase of the fringe images;
calculating depth information from the phase map by the processor; and
performing 3D surface reconstruction based on the depth information and texture image.

43. (canceled)

44. The method of claim 42, wherein the image is captured by a first camera for capturing the fringe images of the three-dimensional object, and a second camera for capturing a color texture image of the object.

45. (canceled)

46. The method of claim 44 wherein the first camera is triggered to capture an image on each off cycle, and the second camera is triggered to capture an image every three off cycles.

47-56. (canceled)

57. The method of claim 42, wherein the processor transforms world coordinates of a point, to distorted camera projective coordinates.

58-66. (canceled)

67. A computer implemented method for three dimensional scanning comprising:
projecting structured light onto a three-dimensional object by a projector;
capturing fringe images of the object by a camera;
processing the fringe images to extract a phase map and a texture image by a processor;
calculating depth information from the phase map by the processor; and
performing 3D surface reconstruction based on the depth information and texture image;
wherein at least one point cloud is generated based on the depth information by the processor and the point cloud is processed by the processor to form a triangle mesh; wherein the processor performs conformal geometry methods for image and shape analysis and real-time tracking applications.

68-70. (canceled)

71. The method of claim 42, wherein an image is captured from two different viewing angles to obtain stereoscopic depth information; wherein the processor uses the stereoscopic depth information as an input into the generation of at least one point cloud.

72. (canceled)

73. The method of claim 42, wherein first fringe images are captured at a first time and used to perform a first 3D surface reconstruction, second fringe images are captured at a second time and used to perform a second 3D reconstruction, and the first and second 3D reconstructions are registered.

74-84. (canceled)
